(19) United States
(12) Patent Application Publication
(10) Pub. No.: US 2026/0239430 A1
(43) Pub. Date: Aug. 13, 2026

(54) EARLY BEAM REFINEMENT VIA RANDOM ACCESS MESSAGE REPETITION FOR A TWO-STEP RANDOM ACCESS PROCEDURE

(71) Applicant: QUALCOMM Incorporated, San Diego, CA (US)

(72) Inventors: In-Soo KIM, San Diego, CA (US); Yan ZHOU, San Diego, CA (US); Jing SUN, San Diego, CA (US); Jing JIANG, San Diego, CA (US)

(21) Appl. No.: 19/048,485

(22) Filed: Feb. 7, 2025

(51) Int. Cl. H04W 74/0833; H04B 7/06; H04W 72/21

(52) U.S. Cl. CPC H04W 74/0833; H04B 7/06958; H04W 72/21

(57) ABSTRACT

Methods, systems, and devices for wireless communications are described. A user equipment (UE) may transmit a random access message that may include a physical random access channel (PRACH) portion and a physical uplink shared channel (PUSCH) portion. To transmit the random access message, the UE may transmit multiple repetitions of the PRACH portion of the random access message via multiple narrow beams associated with a wide beam, and may transmit PUSCH portion of the random access message via the wide beam. The UE may receive a random access response message, where the random access response message may indicate a narrow beam from among the multiple narrow beams. The UE may communicate via the narrow beam in accordance with receiving the random access response message.

### FIELD OF TECHNOLOGY

The following relates to wireless communications, including early beam refinement via random access message repetition for a two-step random access procedure.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

In some implementations, a user equipment (UE) may perform beam refinement to determine a “best” beam with which to transmit messages. In some implementations, the beam refinement may occur after the UE has performed an initial access procedure. For example, the UE may perform a random access procedure to connect with a network entity (e.g., radio resource control (RRC) connection). As part of the initial access procedure, the network entity may transmit multiple synchronization signal blocks (SSBs), each corresponding to a wide beam. The UE may determine a “best” SSB, such as the SSB with the highest reference signal received power (RSRP). The UE may then use the wide beam associated with the best SSB to perform the random access procedure, such as a two-step random access procedure. During the two-step random access procedure, the UE may transmit a random access message (e.g., MsgA) including both a physical random access channel (PRACH) portion (e.g., MsgA-PRACH) and physical uplink shared channel (PUSCH) portion (e.g., MsgA-PUSCH). The network entity may, in response to the random access message, transmit a random access response message (e.g., MsgB). In some cases, after performing the random access procedure, the UE may perform a beam refinement to determine a best narrow beam within the wide beam for transmission. However, performing the beam refinement after the initial access procedure may take time and resources, resulting in increased latency.

The systems, methods, and devices of this disclosure support a UE and a network entity performing early beam refinement within a two-step random access procedure by implementing uplink PRACH repetitions. In some implementations, a UE may operate according to the two-step random access procedure. The UE may determine a wide beam to use for the random access procedure based on an initial transmission of one or more SSBs from the network entity, as described. The UE may then transmit the PRACH portion of a random access message (e.g., MsgA) over one or more narrow beams within the wide beam. That is, the UE may transmit multiple repetitions of the PRACH portion of the random access message via different narrow beams within the wide beam, performing a beam sweep. In some cases, the UE may transmit the PUSCH of the random access message via the wide beam. The network entity may receive the PRACH repetitions and the PUSCH of the random access message, and may determine the “best” narrow beam, such as the narrow beam associated with the received repetition of the PRACH portion with the highest quality, RSRP, or the like. The network entity may indicate the determined narrow beam to the UE in a random access response message (e.g., MsgB), and the UE may then communicate via the indicated narrow beam. In some cases, the UE may transmit, via the indicated narrow beam, a feedback message acknowledging reception and successful decoding of the random access response message to the network entity. Thus, the UE may incorporate the beam refinement for an uplink beam into an initial access procedure, reducing latency and improving communication reliability.

A method for wireless communications by a user equipment (UE) is described. The method may include transmitting a random access message that includes a physical random access channel (PRACH) portion and a physical uplink shared channel (PUSCH) portion, where transmitting the random access message may include operations, features, means, or instructions for transmitting a set of multiple repetitions of the PRACH portion of the random access message via a set of multiple narrow beams associated with a wide beam and transmitting the PUSCH portion of the random access message via the wide beam, receiving a random access response message, where the random access response message indicates a narrow beam from among the set of multiple narrow beams in accordance with transmitting the set of multiple repetitions of the PRACH portion of the random access message, and communicating via the narrow beam in accordance with receiving the random access response message.

A UE for wireless communications is described. The UE may include one or more memories storing processor executable code, and one or more processors coupled with the one or more memories. The one or more processors may individually or collectively be operable to execute the code to cause the UE to transmit a random access message that includes a PRACH portion and a PUSCH portion, where, to transmit the random access message, the one or more processors are individually or collectively operable to execute the code to cause the UE to transmit a set of multiple repetitions of the PRACH portion of the random access message via a set of multiple narrow beams associated with a wide beam and transmit the PUSCH portion of the random access message via the wide beam, receive a random access response message, where the random access response message indicates a narrow beam from among the set of multiple narrow beams in accordance with transmitting the set of multiple repetitions of the PRACH portion of the random access message, and communicate via the narrow beam in accordance with receiving the random access response message.

Another UE for wireless communications is described. The UE may include means for transmitting a random access message that includes a PRACH portion and a PUSCH portion, where the means for transmitting the random access message include means for transmitting a set of multiple repetitions of the PRACH portion of the random access message via a set of multiple narrow beams associated with a wide beam and means for transmitting the PUSCH portion of the random access message via the wide beam, means for receiving a random access response message, where the random access response message indicates a narrow beam from among the set of multiple narrow beams in accordance with transmitting the set of multiple repetitions of the PRACH portion of the random access message, and means for communicating via the narrow beam in accordance with receiving the random access response message.

A non-transitory computer-readable medium storing code for wireless communications is described. The code may include instructions executable by one or more processors to transmit a random access message that includes a PRACH portion and a PUSCH portion, where the instructions to transmit the random access message are executable to transmit a set of multiple repetitions of the PRACH portion of the random access message via a set of multiple narrow beams associated with a wide beam and transmit the PUSCH portion of the random access message via the wide beam, receive a random access response message, where the random access response message indicates a narrow beam from among the set of multiple narrow beams in accordance with transmitting the set of multiple repetitions of the PRACH portion of the random access message, and communicate via the narrow beam in accordance with receiving the random access response message.

Some examples of the method, UEs, and non-transitory computer-readable medium described herein may further include operations, features, means, or instructions for receiving one or more synchronization signal blocks (SSBs), where the wide beam may be associated with a SSB of the one or more SSBs.

In some examples of the method, UEs, and non-transitory computer-readable medium described herein, transmitting the set of multiple repetitions of the PRACH portion of the random access message may include operations, features, means, or instructions for transmitting each repetition of the set of multiple repetitions of the PRACH portion of the random access message in accordance with a transmission power, where the transmission power may be in accordance with a measured path loss associated with the SSB.

Some examples of the method, UEs, and non-transitory computer-readable medium described herein may further include operations, features, means, or instructions for transmitting the set of multiple repetitions of the PRACH portion of the random access message may be in accordance with a reference signal received power (RSRP) associated with the SSB being greater than or equal to a first threshold, being less than a second threshold, or both.

Some examples of the method, UEs, and non-transitory computer-readable medium described herein may further include operations, features, means, or instructions for transmitting a second set of multiple repetitions of the PRACH portion of the random access message via the wide beam in accordance with a RSRP associated with the SSB failing to satisfy a first threshold.

In some examples of the method, UEs, and non-transitory computer-readable medium described herein, communicating via the narrow beam may include operations, features, means, or instructions for transmitting, via the narrow beam, a feedback message indicating successful reception of the random access response message.

In some examples of the method, UEs, and non-transitory computer-readable medium described herein, transmitting the set of multiple repetitions of the PRACH portion of the random access message may include operations, features, means, or instructions for transmitting each of the set of multiple repetitions of the PRACH portion of the random access message using a common preamble.

In some examples of the method, UEs, and non-transitory computer-readable medium described herein, communicating via the narrow beam may include operations, features, means, or instructions for transmitting a second random access message via the narrow beam, the second random access message including a PUSCH message.

Some examples of the method, UEs, and non-transitory computer-readable medium described herein may further include operations, features, means, or instructions for transmitting, prior to receiving the random access response message, at least one additional random access message in accordance with a failure to receive or decode a prior random access response message, where transmitting each additional random access message may include operations, features, means, or instructions for transmitting a set of multiple repetitions of a PRACH portion of the additional random access message via the set of multiple narrow beams associated with the wide beam and transmitting a PUSCH portion of the additional random access message via the wide beam.

In some examples of the method, UEs, and non-transitory computer-readable medium described herein, transmitting the at least one additional random access message may include operations, features, means, or instructions for transmitting one or more additional random access messages until a threshold quantity of random access messages may be satisfied.

Some examples of the method, UEs, and non-transitory computer-readable medium described herein may further include operations, features, means, or instructions for receiving system information indicating a beam sweep configuration, where transmitting the set of multiple repetitions of the PRACH portion of the random access response message may be in accordance with the beam sweep configuration.

In some examples of the method, UEs, and non-transitory computer-readable medium described herein, the beam sweep configuration indicates a quantity of repetitions of the PRACH portion of the random access message, a threshold quantity of random access message retransmissions, a fallback random access message transmission configuration, or any combination thereof.

In some examples of the method, UEs, and non-transitory computer-readable medium described herein, the beam sweep configuration indicates a set of multiple sets of ROs, the one or more processors may be individually or collectively operable to execute the code to cause the UE to transmit the set of multiple repetitions of the PRACH portion of the random access message via a set of random access channel occasions (ROs) from among the set of multiple sets of ROs, the beam sweep configuration indicates a set of multiple PUSCH occasions (POs), each PO may be associated with a respective set of ROs among the set of multiple sets of ROs, and the one or more processors may be individually or collectively operable to execute the code to cause the UE to transmit the PUSCH portion of the random access message via a PO associated with the set of ROs.

Some examples of the method, UEs, and non-transitory computer-readable medium described herein may further include operations, features, means, or instructions for selecting, by the UE, the set of ROs from among the set of multiple sets of ROs.

A method for wireless communications by a network entity is described. The method may include receiving a random access message that includes a PRACH portion and a PUSCH portion, where receiving the random access message may include operations, features, means, or instructions for receiving a set of multiple repetitions of the PRACH portion of the random access message via a set of multiple narrow beams associated with a wide beam and receiving the PUSCH portion of the random access message via the wide beam, transmitting a random access response message, where the random access response message indicates a narrow beam from among the set of multiple narrow beams in accordance with receiving the set of multiple repetitions of the PRACH portion of the random access message, and communicating via the narrow beam in accordance with transmitting the random access response message.

A network entity for wireless communications is described. The network entity may include one or more memories storing processor executable code, and one or more processors coupled with the one or more memories. The one or more processors may individually or collectively be operable to execute the code to cause the network entity to receive a random access message that includes a PRACH portion and a PUSCH portion, where, to receive the random access message, the one or more processors are individually or collectively operable to execute the code to cause the network entity to receive a set of multiple repetitions of the PRACH portion of the random access message via a set of multiple narrow beams associated with a wide beam and receive the PUSCH portion of the random access message via the wide beam, transmit a random access response message, where the random access response message indicates a narrow beam from among the set of multiple narrow beams in accordance with receiving the set of multiple repetitions of the PRACH portion of the random access message, and communicate via the narrow beam in accordance with transmitting the random access response message.

Another network entity for wireless communications is described. The network entity may include means for receiving a random access message that includes a PRACH portion and a PUSCH portion, where the means for receiving the random access message include means for receiving a set of multiple repetitions of the PRACH portion of the random access message via a set of multiple narrow beams associated with a wide beam and means for receiving the PUSCH portion of the random access message via the wide beam, means for transmitting a random access response message, where the random access response message indicates a narrow beam from among the set of multiple narrow beams in accordance with receiving the set of multiple repetitions of the PRACH portion of the random access message, and means for communicating via the narrow beam in accordance with transmitting the random access response message.

A non-transitory computer-readable medium storing code for wireless communications is described. The code may include instructions executable by one or more processors to receive a random access message that includes a PRACH portion and a PUSCH portion, where the instructions to receive the random access message are executable to receive a set of multiple repetitions of the PRACH portion of the random access message via a set of multiple narrow beams associated with a wide beam and receive the PUSCH portion of the random access message via the wide beam, transmit a random access response message, where the random access response message indicates a narrow beam from among the set of multiple narrow beams in accordance with receiving the set of multiple repetitions of the PRACH portion of the random access message, and communicate via the narrow beam in accordance with transmitting the random access response message.

Some examples of the method, network entities, and non-transitory computer-readable medium described herein may further include operations, features, means, or instructions for transmitting one or more SSBs, where the wide beam may be associated with a SSB of the one or more SSBs.

In some examples of the method, network entities, and non-transitory computer-readable medium described herein, receiving the set of multiple repetitions of the PRACH portion of the random access message may include operations, features, means, or instructions for receiving each repetition of the set of multiple repetitions of the PRACH portion of the random access message in accordance with a transmission power, where the transmission power may be in accordance with transmitting the SSB.

Some examples of the method, network entities, and non-transitory computer-readable medium described herein may further include operations, features, means, or instructions for receiving the set of multiple repetitions of the PRACH portion of the random access message may be in accordance with a RSRP associated with the SSB being greater than or equal to a first threshold, being less than a second threshold, or both.

Some examples of the method, network entities, and non-transitory computer-readable medium described herein may further include operations, features, means, or instructions for receiving a second set of multiple repetitions of the PRACH portion of the random access message via the wide beam in accordance with a RSRP associated with the SSB failing to satisfy a first threshold.

In some examples of the method, network entities, and non-transitory computer-readable medium described herein, communicating via the narrow beam may include operations, features, means, or instructions for receiving, via the narrow beam, a feedback message indicating successful reception of the random access response message.

Some examples of the method, network entities, and non-transitory computer-readable medium described herein may further include operations, features, means, or instructions for identifying, for an earliest detected repetition of the PRACH portion of the random access message from among the set of multiple repetitions of the PRACH portion of the random access message, a radio network temporary identifier that may be associated with a RO corresponding to the earliest detected repetition and transmitting a control message that schedules the random access response message, where the control message may be associated with the radio network temporary identifier in accordance with the radio network temporary identifier being associated with the RO corresponding to the earliest detected repetition.

In some examples of the method, network entities, and non-transitory computer-readable medium described herein, receiving the set of multiple repetitions of the PRACH portion of the random access message may include operations, features, means, or instructions for receiving each of the set of multiple repetitions of the PRACH portion of the random access message using a common preamble.

In some examples of the method, network entities, and non-transitory computer-readable medium described herein, communicating via the narrow beam may include operations, features, means, or instructions for receiving a second random access message via the narrow beam, the second random access message including a PUSCH message.

Some examples of the method, network entities, and non-transitory computer-readable medium described herein may further include operations, features, means, or instructions for receiving, prior to transmitting the random access response message, at least one additional random access message in accordance with a reception or decoding failure for a prior random access response message, where receiving each additional random access message may include operations, features, means, or instructions for receiving a set of multiple repetitions of a PRACH portion of the additional random access message via the set of multiple narrow beams associated with the wide beam and receiving a PUSCH portion of the additional random access message via the wide beam.

In some examples of the method, network entities, and non-transitory computer-readable medium described herein, receiving the at least one additional random access message may include operations, features, means, or instructions for receiving one or more additional random access messages until a threshold quantity of random access messages may be satisfied.

Some examples of the method, network entities, and non-transitory computer-readable medium described herein may further include operations, features, means, or instructions for transmitting system information indicating a beam sweep configuration, where transmitting the set of multiple repetitions of the PRACH portion of the random access response message may be in accordance with the beam sweep configuration.

In some examples of the method, network entities, and non-transitory computer-readable medium described herein, the beam sweep configuration indicates a quantity of repetitions of the PRACH portion of the random access message, a threshold quantity of random access message retransmissions, a fallback random access message transmission configuration, or any combination thereof.

Some examples of the method, network entities, and non-transitory computer-readable medium described herein may further include operations, features, means, or instructions for receiving the set of multiple repetitions of the PRACH portion of the random access message may be via a set of ROs from among the set of multiple sets of ROs, and where the beam sweep configuration indicates a set of multiple POs, where each PO may be associated with a respective set of ROs among the set of multiple sets of ROs, and where receiving the PUSCH portion of the random access message may be via a PO associated with the set of ROs.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIGS. 1 and 2 show examples of wireless communications systems that support early beam refinement via random access message repetition for a two-step random access procedure in accordance with one or more aspects of the present disclosure.

FIG. 3 shows an example of a timing diagram that supports early beam refinement via random access message repetition for a two-step random access procedure in accordance with one or more aspects of the present disclosure.

FIG. 4 shows an example of a block diagram that supports early beam refinement via random access message repetition for a two-step random access procedure in accordance with one or more aspects of the present disclosure.

FIG. 5 shows an example of a process flow that supports early beam refinement via random access message repetition for a two-step random access procedure in accordance with one or more aspects of the present disclosure.

FIGS. 6 and 7 show block diagrams of devices that support early beam refinement via random access message repetition for a two-step random access procedure in accordance with one or more aspects of the present disclosure.

FIG. 8 shows a block diagram of a communications manager that supports early beam refinement via random access message repetition for a two-step random access procedure in accordance with one or more aspects of the present disclosure.

FIG. 9 shows a diagram of a system including a device that supports early beam refinement via random access message repetition for a two-step random access procedure in accordance with one or more aspects of the present disclosure.

FIGS. 10 and 11 show block diagrams of devices that support early beam refinement via random access message repetition for a two-step random access procedure in accordance with one or more aspects of the present disclosure.

FIG. 12 shows a block diagram of a communications manager that supports early beam refinement via random access message repetition for a two-step random access procedure in accordance with one or more aspects of the present disclosure.

FIG. 13 shows a diagram of a system including a device that supports early beam refinement via random access message repetition for a two-step random access procedure in accordance with one or more aspects of the present disclosure.

FIGS. 14 through 16 show flowcharts illustrating methods that support early beam refinement via random access message repetition for a two-step random access procedure in accordance with one or more aspects of the present disclosure.

### DETAILED DESCRIPTION

In some wireless communications systems, a user equipment (UE) may perform beam refinement to determine a “best” beam with which to transmit messages. In some implementations, the beam refinement may occur after the UE has performed an initial access procedure. For example, the UE may perform a random access procedure to connect with a network entity (e.g., radio resource control (RRC) connection). As part of the initial access procedure, the network entity may transmit multiple synchronization signal blocks (SSBs), each corresponding to a wide beam. The UE may determine a “best” SSB, such as the SSB with the highest reference signal received power (RSRP). The UE may then use the wide beam associated with the best SSB to perform the random access procedure. In some cases, the random access procedure may be a two-step random access procedure. During the two-step random access procedure, the UE may transmit a random access message (e.g., MsgA) including both a physical random access channel (PRACH) portion (e.g., MsgA-PRACH) and physical uplink shared channel (PUSCH) portion (e.g., MsgA-PUSCH). The network entity may, in response to the random access message, transmit a random access response message (e.g., MsgB). In some cases, after performing the random access procedure, the UE may perform a beam refinement to determine a best narrow beam within the wide beam for transmission. However, performing the beam refinement after the initial access procedure may take time and resources, resulting in increased latency.

The techniques described herein support a UE and a network entity performing early beam refinement within a two-step random access procedure by implementing uplink PRACH repetitions. In some implementations, a UE may operate according to the two-step random access procedure. The UE may determine a wide beam to use for the random access procedure based on an initial transmission of one or more SSBs from the network entity, as described. The UE may then transmit the PRACH portion of a random access message (e.g., MsgA) over one or more narrow beams within the wide beam. That is, the UE may transmit multiple repetitions of the PRACH portion of the random access message via different narrow beams within the wide beam, performing a beam sweep. In some cases, the UE may transmit the PUSCH of the random access message via the wide beam. The network entity may receive the PRACH repetitions and the PUSCH of the random access message, and may determine the “best” narrow beam, such as the narrow beam associated with the received repetition of the PRACH portion with the highest quality, RSRP, or the like. The network entity may indicate the determined narrow beam to the UE in a random access response message (e.g., MsgB), and the UE may then communicate via the indicated narrow beam. In some cases, the UE may transmit, via the indicated narrow beam, a feedback message acknowledging reception and successful decoding of the random access response message to the network entity. Thus, the UE may incorporate the beam refinement for an uplink beam into an initial access procedure, reducing latency and improving communication reliability.

Aspects of the disclosure are initially described in the context of wireless communications systems, timing diagrams, block diagrams, and process flows. Aspects of the disclosure are further illustrated by and described with reference to apparatus diagrams, system diagrams, and flowcharts that relate to early beam refinement via random access message repetition for a two-step random access procedure.

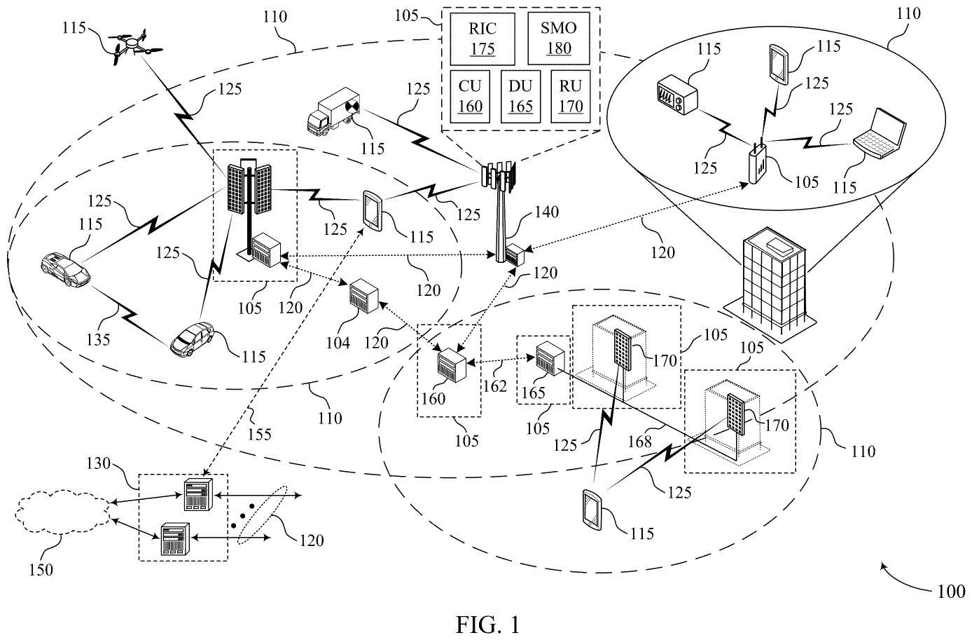

FIG. 1 shows an example of a wireless communications system 100 that supports early beam refinement via random access message repetition for a two-step random access procedure in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support early beam refinement via random access message repetition for a two-step random access procedure as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some wireless communications systems 100, a UE 115 may perform beam refinement to determine a best beam with which to transmit messages. In some implementations, the beam refinement may occur after the UE 115 has performed an initial access procedure. For example, the UE 115 may perform a random access procedure to connect with a network entity 105 (e.g., RRC connection). As part of the initial access procedure, the network entity 105 may transmit multiple SSBs, each corresponding to a wide beam. The UE 115 may determine a “best” SSB, such as the SSB with the highest reference signal received power (RSRP). The UE 115 may then use the wide beam associated with the best SSB to perform the random access procedure. In some cases, the random access procedure may be a two-step random access procedure. During the two-step random access procedure, the UE 115 may transmit a random access message (e.g., MsgA) including both a PRACH portion (e.g., MsgA-PRACH) and PUSCH portion (e.g., MsgA-PUSCH). The network entity 105 may, in response to the random access message, transmit a random access response message (e.g., MsgB). In some cases, after performing the random access procedure, the UE 115 may perform a beam refinement to determine a best narrow beam within the wide beam for transmission.

In some implementations, a UE 115 and a network entity 105 may perform early beam refinement within a two-step random access procedure by implementing uplink PRACH repetitions. In some implementations, the UE 115 may operate according to the two-step random access procedure. The UE 115 may determine a wide beam to use for the random access procedure based on an initial transmission of one or more SSBs from the network entity 105, as described. The UE 115 may then transmit the PRACH portion of a random access message (e.g., MsgA) over one or more narrow beams within the wide beam. That is, the UE 115 may transmit multiple repetitions of the PRACH portion of the random access message via different narrow beams within the wide beam, performing a beam sweep. In some cases, the UE 115 may transmit the PUSCH of the random access message via the wide beam. The network entity 105 may receive the PRACH repetitions and the PUSCH of the random access message, and may determine the “best” narrow beam, such as the narrow beam associated with the received repetition of the PRACH portion with the highest quality, RSRP, or the like. The network entity 105 may indicate the determined narrow beam to the UE 115 in a random access response message (e.g., MsgB), and the UE 115 may then communicate via the indicated narrow beam. In some cases, the UE 115 may transmit, via the indicated narrow beam, a feedback message acknowledging reception and successful decoding of the random access response message to the network entity 105. Thus, the UE 115 may incorporate the beam refinement for an uplink beam into an initial access procedure, reducing latency and improving communication reliability.

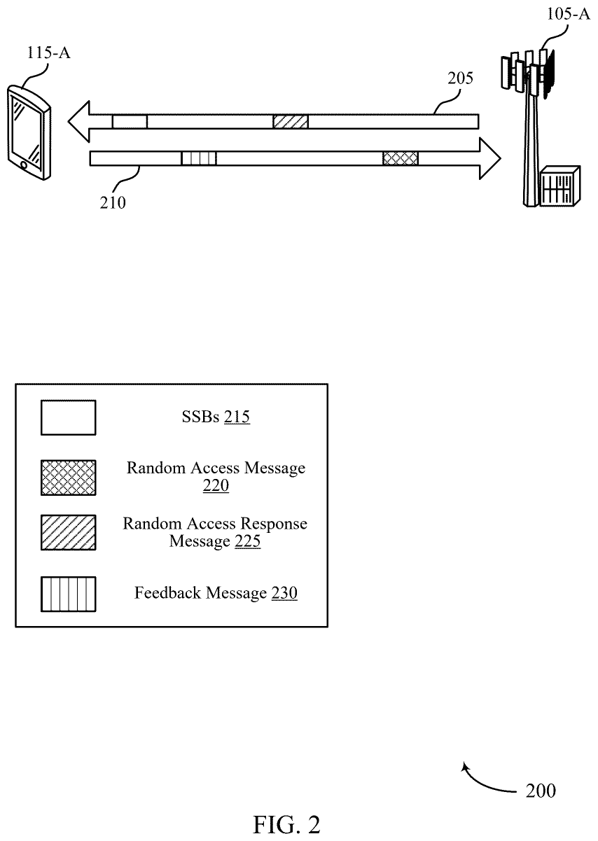

FIG. 2 shows an example of a wireless communications system 200 that supports early beam refinement via random access message repetition for a two-step random access procedure in accordance with one or more aspects of the present disclosure. The wireless communications system 200 may implement, or be implemented by, aspects of the wireless communications system 100. For example, the wireless communications system 200 may include one or more network entities 105 and one or more UEs 115, including at least the network entity 105-a and UE 115-a, which may be examples of corresponding devices as described herein, including with reference to FIG. 1. The techniques described herein in the context of the wireless communications system 200 may support a UE 115-a performing a beam sweep during two-step random access procedure.

In some wireless communications systems 200, an idle UE 115-a may perform an initial access operation to communicate with the network entity 105-a in a connected state (e.g., RRC_connected). In some implementations, wireless communication system 200 may support multi-beam operation, which may implement beam refinement for determining one or more beams for communication. In some cases, the network entity 105-a may, after an initial access procedure (e.g., after RRC setup may be complete), trigger aperiodic beam refinement (e.g., P2 and P3 beam refinement) via a downlink message (e.g., Msg5, after a four-step random access procedure). In some examples, the network entity 105-a may also transmit an indication of a transmission configuration indicator (TCI) via the downlink message. For example, after RRC setup may be complete, the network entity 105-a may trigger an aperiodic beam report (e.g., P2 beam report) for beam refinement at the network entity 105-a. Based on the aperiodic beam report, the network entity 105-a may send a TCI activation medium access control-control element (MAC-CE) to activate or indicate the TCI for a narrow beam (e.g., the desired narrow beam) at the network entity 105-a, such as a transmission beam at the network entity 105-a. For the indicated TCI, further aperiodic beam refinement (e.g., P3 beam refinement) may be triggered to refine a corresponding beam at the UE 115-a, such as a reception beam at the UE 115-a. The refined beam (e.g., the network entity 105-a and UE 115-a beam) may be applied to following message exchanges. However, aperiodic beam refinement (e.g., P2 and P3 beam refinement) may be slow, as it may begin after RRC setup is completed. In some cases, aperiodic beam refinement may also use multiple slots (e.g., 30 slots for a subcarrier spacing (SCS) of 120 kHz, 5 slots for SCS of 15 kHz), taking up communication resources.

In some implementations, a network entity 105-a may be able to perform beam refinement as part of a random access procedure. For example, the UE 115-a and the network entity 105-a may perform a four-step random access procedure. During the four-step random access procedure, the network entity 105-a may transmit SSBs 215 to the UE 115-a, where each SSB may be transmitted according to a different wide beam. The UE 115-a may determine a wide beam based on the SSBs 215. For example, the UE 115-a may determine to use a wide beam associated with an SSB 215 with the highest RSRP, or based on some other metric. The UE 115-a may then transmit a random access preamble message (e.g., Msg1), which may be a PRACH message. The network entity may respond with a random access response message (e.g., Msg2), which may include or indicate an uplink grant for transmission of an uplink scheduled random access message (e.g., Msg 3). The UE 115-a may transmit the uplink scheduled random access message, which may be a PUSCH message, based on the uplink grant. The network entity 105-a may respond with a downlink random access message (Msg 4), which may confirm the success of the random access procedure.

In some cases, the UE 115-a may transmit multiple repetitions of the random access preamble message (e.g., the PRACH message). For example, the UE 115-a may transmit the random access preamble message multiple times via the wide beam. The network entity 105-a may perform a beam sweep on the random access preamble message transmissions, such that each repetition may be associated with a narrow band within the wide band. The repetitions may include sequence repetition within a preamble format (e.g., R15 preamble format, R18 preamble format). The network entity 105-a may receive the repetitions of the random access preamble message, and may determine a narrow beam based on the repetition with the greatest RSRP, or some other metric. That is, the network entity 105-a may use the repetitions of the random access preamble message to perform beam refinement. The network entity 105-a may use the refined narrow beam for transmission of proceeding messages (e.g., for downlink transmission and uplink reception). For example, the network entity 105-a may transmit a random access response message with the refined narrow beam. In some examples, this may save or reduce a quantity of required repetitions within the beam refinement process, while achieving a similar coverage to performing the beam refinement after the initial access. However, the UE 115-a may still transmit messages, such as the uplink scheduled random access message, via the wide beam. That is, the UE 115-a may lack a refined beam during the initial access procedure (e.g., no early beam refinement for UE 115-a transmissions via uplink 210).

In some cases, the UE 115-a may also perform early beam refinement during an initial access procedure. For example, during the four-step random access procedure, the UE 115-a may transmit repetitions of the random access preamble message via multiple narrow beams. That is, each repetition may be transmitted using a different narrow beam, allowing the UE 115-a to perform a beam sweep of the narrow beams. The network entity 105-a may receive the repetitions of the random access preamble message and may determine a “best” narrow beam based on RSRP, quality, or some other metric of the received repetitions of the random access preamble message. The network entity 105-a may transmit the random access response message, which may indicate the refined narrow beam, and the UE 115-a may use the refined narrow beam for proceeding transmissions. For example, the UE 115-a may transmit the uplink scheduled random access message via the refined narrow beam. In some cases, the network entity 105-a may transmit the random access message (e.g., Msg 4) via the wide beam, and the UE 115-a may use the refined beam for reception of the random access message. Thus, for a four-step random access procedure, the UE 115-a may perform early beam refinement.

In some implementations, the UE 115-a may perform initial access via a two-step random access procedure. That is, the UE 115-a may receive SSBs 215 and may determine a wide beam to use for the random access procedure based on the SSBs 215. The UE 115-a may, using the determined wide beam, transmit a random access message 220 (e.g., MsgA). The random access message 220 for a two-step random access procedure may combine aspects of the random access preamble message and the uplink scheduled random access message of the four-step random access procedure. For example, the random access message 220 may include a PRACH portion, which may be associated with a preamble, and a PUSCH portion. The network entity 105-a may receive the random access message 220, and may transmit a random access response message 225 (e.g., MsgB), which may combine aspects of the random access messages (e.g., Msg 2 and Msg4) of the four-step random access procedure. In some cases, the UE 115-a may transmit a feedback message 230 to acknowledge successful reception and decoding of the random access response message 225 (e.g., ACK, MsgB ACK), or to indicate unsuccessful reception or decoding of the random access response message 225 (e.g., NACK, MsgB NACK).

In some cases, the UE 115-a may perform early beam refinement for the two-step random access procedure. That is, a portion of the random access message 220 may be repeated to support UE 115-a early beam refinement. For example, the UE 115-a may transmit repetitions of the PRACH portion of the random access message 220 via different narrow beams within the wide beam, performing a beam sweep. In some examples, the UE 115-a may transmit the PUSCH portion of the random access message 220 via the wide beam. The network entity 105-a may receive the repetitions of the PRACH portion and the PUSCH portion, and may transmit the random access response message 225, which may indicate the “best” narrow beam (e.g., the narrow beam associated with the received PRACH repetition with the highest RSRP, best quality, or the like). The UE 115-a may use the refined narrow beam (e.g., the best narrow beam) for proceeding transmissions, such as transmission of the feedback message 230. Thus, the UE may incorporate the beam refinement for an uplink beam into an initial access procedure, reducing latency and improving communication reliability.

In some examples, the network entity 105-a may fail to decode the PUSCH portion of the random access message 220. The network entity 105-a and UE 115-a may default to a four-step random access procedure, and the UE 115-a may send proceeding transmissions via the wide beam or via an indicated narrow beam. In some examples, the UE 115-a may determine whether to perform early beam refinement based on a RSRP of one or more of the SSBs 215. In some examples, the UE 115-a may fail to decode the random access response message 225. The UE 115-a may repeat the beam transmission of the random access message with the beam sweep some threshold quantity of times. The UE 115-a may determine to use a different beam configuration if the beam sweep fails some threshold quantity of times, which may be configured or indicated by the network entity 105-a. In some examples, the network entity 105-a may indicate a beam sweep configuration, which may include information regarding the beam refinement procedure, via some signaling. In some examples, the UE 115-a may transmit the PRACH repetitions of the random access message 220 according to some uplink power.

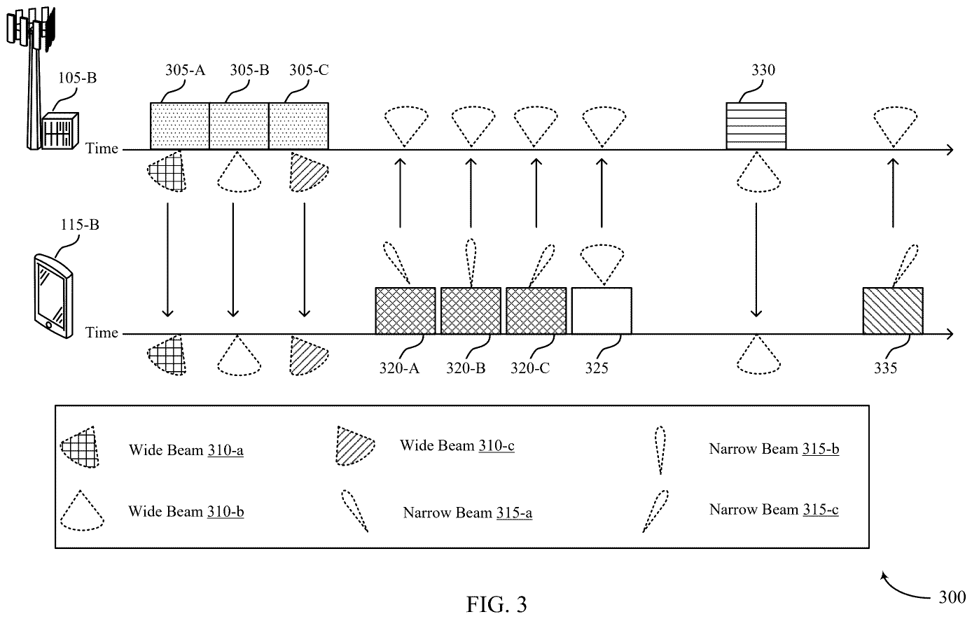

FIG. 3 shows an example of a timing diagram 300 that supports early beam refinement via random access message repetition for a two-step random access procedure in accordance with one or more aspects of the present disclosure. The timing diagram 300 may implement, or be implemented by, aspects of the wireless communications systems 100 and 200. For example, the timing diagram 300 may include one or more network entities 105 and one or more UEs 115, including at least the network entity 105-b and UE 115-b, which may be examples of corresponding devices as described herein, including with reference to FIGS. 1 and 2. The techniques described herein in the context of the timing diagram 300 may support a UE 115-a performing a beam sweep during two-step random access procedure by transmitting PRACH repetitions 320 of a PRACH portion of a random access message.

In some wireless communications systems, a UE 115-b may implement early beam refinement during a two-step random access procedure. For example, the UE 115-b may receive SSBs 305. In some cases, each SSB 305 may be transmitted and received via a wide beam 310. For example, SSB 305-a may be transmitted via wide beam 310-a. SSB 305-b may be transmitted via wide beam 310-b. SSB 305-c may be transmitted via wide beam 310-c. The UE 115-b may receive the SSBs 305 via the respective wide beams 310. In some cases, the UE 115-b may determine (e.g., select, choose) an SSB 305 associated with a wide beam 310 (e.g., the best SSB). The UE may select the SSB 305 based on the SSB 305 with the highest RSRP, best quality, or some other metric to determine the best SSB 305. For example, the SSB 305-b may be received with the highest RSRP at the UE 115-b. The UE 115-b may select the SSB 305-b and may operate using the wide beam 310-b. That is, the UE 115-b may select the SSB 305-b, which may correspond to an initial beam selection of the wide beam 310-b.

In some implementations, the UE 115-b may perform a beam sweep within the wide beam 310-b, sweeping narrow beams 315. In some cases, the UE 115-b may transmit multiple repetitions of a PRACH (e.g., PRACH portion, PRACH repetitions 320) of a random access message (e.g., MsgA) via narrow beams 315 within the wide beam 310-b. That is, the UE 115-b may transmit the PRACH repetitions 320 via random access channel occasions (ROs) associated with the SSB 305-b. For example, the UE 115-b may transmit a PRACH repetition 320-a (e.g., first PRACH) via narrow beam 315-a, a PRACH repetition 320-b via narrow beam 315-b, and a PRACH repetition 320-c via narrow beam 315-c. In some cases, the UE 115-b may transmit multiple PRACH repetitions 320 via one or more of the narrow beams 315. For example, UE 115-b may transmit the PRACH repetition 320-b and the PRACH repetition 320-c via the same narrow beam (e.g., narrow beam 315-b). Each PRACH repetition 320 may be transmitted via an RO associated with the SSB 305-b. In some cases, the UE 115-b may transmit a PUSCH 325 (e.g., PUSCH portion) of the random access message. The network entity 105-b may receive the PRACH repetitions 320 and the PUSCH 325 via the wide beam 310-b. In other cases, the UE 115-b may transmit a single PRACH 320 via the wide beam 310-b, and may transmit multiple repetitions of the PUSCH 325 in order to perform a beam sweep.

In some cases, the network entity 105-b may assess the received PRACH repetitions 320 (or the received PUSCH repetitions 325), and may indicate a narrow beam associated with one or more of the received PRACH repetitions 320 to the UE 115-b via a random access response message (e.g., MsgB). In some examples, the network entity 105-b may select a “best” narrow beam based on an RSRP associated with one of the received PRACH repetitions 320, or based on some other metric. For example, the network entity 105-b may select the narrow beam 315-c. The network entity 105-b may transmit a random access response message 330, which may indicate the narrow beam 315-c to the UE 115-b. In some examples, the random access response message may indicate the PRACH repetition 320-c associated with the narrow beam 315-c, which may act as an indication of the narrow beam 315-c for the UE 115-b. In some cases, the network entity 105-b may transmit the random access response message 330 via the wide beam 310-b, and the UE 115-b may receive the random access response message 330 via the wide beam 310-b. After receiving the indication of the narrow beam 315-c in the random access response message 330, the UE 115-b may communicate using the narrow beam 315-c. That is, the UE 115-b may use the narrow beam 315-b (e.g., a refined beam) for future transmissions. For example, the UE 115-b may transmit an uplink feedback message 335 (e.g., an ACK/NACK message) via the narrow beam 315-c, and the network entity 105-b may receive the uplink feedback message 335 via the wide beam 310-b.

In some implementations, the UE 115-b may transmit the PRACH repetitions 320 using a common or same preamble. In some implementations, a radio network temporary identifier (RNTI) associated with the random access response message 330 may be based on an RO associated with receiving a PRACH 320. For example, the RNTI may be based on a time domain and frequency domain location of an RO. However, each PRACH repetition 320 may be transmitted in a different RO. Thus, the RNTI for the random access response message 330 may be based on a first detected RO. That is, the RNTI may be based on the RO associated with the first PRACH repetition that the network entity 105-b successfully detects. For example, if the network entity 105-b fails to detect the PRACH repetition 320-a and does detect the PRACH repetition 320-b, the RNTI may be based on the RO associated with the PRACH repetition 320-b.

In some implementations, the network entity 105-b may fail to decode the PUSCH 325. In order to retransmit the PUSCH 325, the UE 115-b and the network entity 105-b may fall back to a four-step random access procedure. That is, the UE 115-b may transmit a second uplink random access message (e.g., Msg 3), which may include the PUSCH 325. The network entity 105-b may transmit a fallback random access response message 330, which may indicate for the UE 115-b to continue the random access procedure, or transition to the four-step random access procedure. The network entity 105-b may successfully receive and decode the PRACH repetitions 320, and may transmit the fallback random access response message 330. The fallback random access response message may include random access preamble identifiers (RAPID), timing advance commands, scheduling grants for transmission of the second random access message, temporary cell-RNTI (TC-RNTI), and beam identifiers. In some cases, the network entity 105-b may indicate the “best” narrow beam 315, such as the narrow beam 315-c, to use for later messages in the fallback random access response message 330. The UE 115-b may transmit the second uplink random access message via the narrow beam 315-c. In other cases, the network entity 105-b may transmit the fallback random access response message 330, which may implicitly indicate for the UE 115-b to operate using the beam associated with the PUSCH 325. That is, the UE 115-b may transmit the second random access message and later messages via the wide beam 310-b.

In some implementations, the UE 115-b may determine a beam sweep configuration to use for a random access procedure. For example, the UE 115-b may determine whether to implement a two-step random access procedure with beam sweeping via the PRACH repetitions 320. The UE 115-b may select between multiple beam sweep configurations, or broader random access procedure configurations. The UE 115-b may select the beam sweep configuration based on an RSRP of the SSB 305-b satisfying a threshold. In some cases, the threshold may be indicated by the network entity 105-b via system information (e.g., remaining minimum system information (RMSI)). In some cases, the network entity 105-c may indicate multiple thresholds that may indicate which beam sweep configuration or random access procedure configuration the UE 115-c may implement.

For example, the UE 115-c may implement a two-step random access procedure without beam sweeping for a highest SSB RSRP, or when an RSRP is above a first threshold (e.g., highest threshold). That is, the UE 115-b may not refine a transmission beam from the wide beam 310-b if the wide beam, as indicated by the SSB 305-b, is strong enough. If the RSRP of the SSB 305-b is below the first threshold and above a second threshold, the UE 115-b may implement the two-step random access procedure with beam sweeping, as described herein. That is, the UE 115-b may transmit the random access message with PRACH repetitions 320 via narrow beams 315. If the RSRP of the SSB 305-b is below the second threshold and above a third threshold, the UE 115-b may implement a two-step random access procedure with beam repetition. That is, the UE 115-b may transmit the random access message with PRACH repetitions 320, but may transmit teach PRACH repetition via the wide beam 310-b (e.g., rather than narrow beams 315). For the two-step random access procedure with beam repetition, the random access response message 330 may not indicate a “best” beam, as each PRACH repetition 320 may be transmitted via the wide beam 310-b. The UE 115-b may use the wide beam 310-b for the rest of the initial access procedure and communication, until a beam refinement may be performed.

In some cases, if the RSRP of the SSB 305-b is below the third threshold but above a fourth threshold, the UE 115-c may implement a four-step random access procedure. If the RSRP is below the fourth threshold, but above a fifth threshold, the UE 115-b may implement a four-step random access procedure with beam sweeping (e.g., repetition of the first random access message (e.g., Msg1) via multiple narrow beams). If the RSRP is below the fifth threshold, the UE 115-b may implement a four-step random access procedure with beam repetition (e.g., repetition of the first random access message via a wide beam). The threshold and beam sweep configurations, as well as random access procedure configurations, described herein are given as examples. The configurations may include some or all of these options, may be in any order, and may be associated with any quantity of thresholds.

In some implementations, the network entity 105-b may indicate a beam sweep configuration (or a random access procedure configuration), such as the two-step random access procedure with beam sweeping. That is, the network entity 105-b may transmit an indication to the UE 115-b of the beam sweep configuration to implement. In some cases, the network entity 105-b may send the indication via system information (e.g., RMSI). The network entity 105-b may also indicate a quantity of PRACH repetitions 320 for the beam sweep configuration in the system information (e.g., rach-ConfigCommonTwoStepRA in the RMSI). In some cases, a quantity of narrow beams 315 may be different from the quantity of PRACH repetitions 320 indicated or configured by the network entity 105-b. In some cases, the UE 115-b may determine or choose how to perform the beam sweep (e.g., up to UE implementation). If the quantity of narrow beams 315 is less than the quantity of PRACH repetitions 320, the UE 115-b may sweep all the narrow beams 315, and may repeat some of the narrow beams 315 for some PRACH repetitions 320 transmissions. For example, if the network entity 105-b indicated to transmit three PRACH repetitions 320, but only narrow beams 315-a and 315-b, the UE 115-b may transmit the PRACH repetition 320-c via the narrow beam 315-a, or via the narrow beam 315-b. If the quantity of narrow beams 315 is less than the quantity of PRACH repetitions 320, the UE 115-b may sweep a subset of the narrow beams 315 across the PRACH repetition 320 transmissions. For example, if the network entity 105-b indicated to transmit two PRACH repetitions 320, the UE 115-b may not transmit a PRACH repetition 320 via the narrow beam 315-c. In other cases, the network entity 105-b may indicate or configure the UE 115-b to skip or repeat narrow beams 315.

In some implementations, the UE 115-b may fail to decode the random access response message 330. In response, the UE 115-b may repeat the transmission of the random access message, and may retransmit the PRACH repetitions 320 and the PUSCH 325. In some cases, the UE 115-b may repeat the transmission of the random access message with the beam sweep up to a threshold quantity of retransmissions (e.g., msgA-TransMax). In some examples, the network entity 105-b may indicate the threshold quantity of retransmissions via system information (e.g., msgA-TransMax in RMSI). For example, the UE 115-b may repeatedly fail to decode the random access response message 330, and may repeatedly retransmit the random access message until the UE 115-b successfully decodes the random access response message or reaches the threshold quantity of retransmissions. In some cases, the network entity 105-b may indicate or configure the behavior of the UE 115-b, if the UE 115-b reaches the threshold quantity of retransmissions, via the system information (e.g., RMSI). For example, if the UE 115-b reaches the threshold quantity of retransmissions, the network entity 105-b may indicate that the UE 115-b may implement a different beam sweep configuration or random access procedure configuration. For example, the UE 115-b may default or fallback to a four-step random access procedure without a beam sweep if the UE 115-b reaches the threshold quantity of retransmissions.

In some implementations, the UE 115-b may transmit each PRACH repetition 320 with a same uplink transmit power. That is, the UE 115-b may implement the same or common transmit power control (TPC) parameters across the narrow beams 315. In this way, the network entity 105-b may be able to determine the “best” narrow beam 315 based on the RSRP of the narrow beams 315 and based on the common uplink transmit power constraint. In some cases, uplink transmit power may be determined based on a path loss. For example, uplink transmit power may be a minimum value between a maximum transmit power at the UE 115-b and a sum of a pre-configured received power target (e.g., P₀), a TPC parameter alpha (e.g., a fractional power control), a TPC parameter delta (e.g., a close loop power control component), and a path loss (e.g., PL). In examples, the path loss may be measured from the SSB 305-b (e.g., the “best” or selected SSB) received via the initial beam (e.g., the wide beam 310-b). In some examples, the other parameters to determine the uplink transmit power may be determined or configured as if the UE 115-b may perform a two-step random access procedure without the beam sweep. In other examples, the other parameters to determine the uplink transmit power may be configured, indicated, or selected for the two-step random access procedure with the beam sweep. For example, the other parameters may be configured to avoid saturation of an analog-to-digital converter based on the high beamforming gain of using the narrow beams 315. That is, in order for the network entity 105-b to successfully measure the RSRP of the PRACH repetitions 320, the uplink transmit power of the PRACH repetitions 320 may be adjusted (e.g., lowered or reduced).

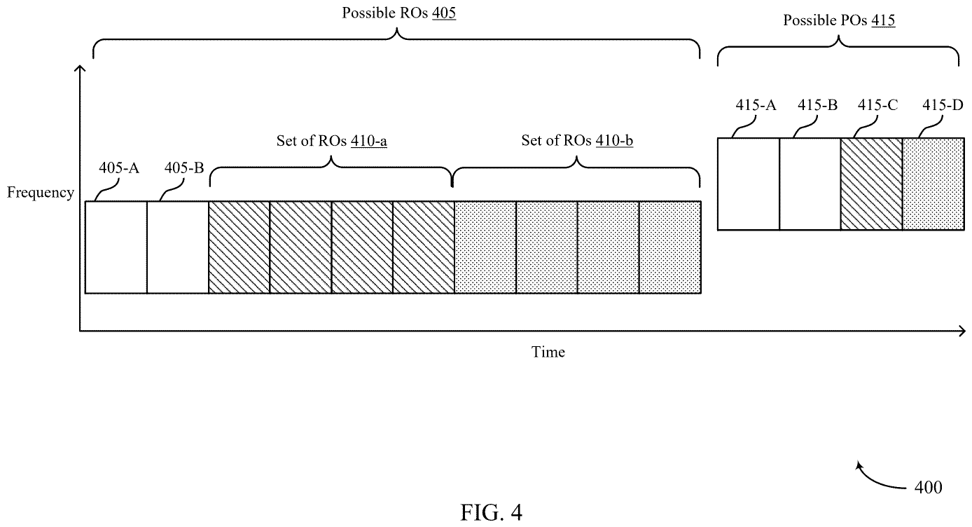

FIG. 4 shows an example of a block diagram 400 that supports early beam refinement via random access message repetition for a two-step random access procedure in accordance with one or more aspects of the present disclosure. The block diagram 400 may implement, or be implemented by, aspects of the wireless communications systems 100 and 200 and the timing diagram 300. The techniques described herein in the context of the block diagram 400 may support a UE 115-a performing a beam sweep during two-step random access procedure by mapping sets of ROs 410 for transmission of repetitions of a PRACH portion of a random access message to POs (POs) 415 for transmission of a PUSCH portion of a random access message.

In some wireless communications systems, a two-step random access procedure may be implemented such that a PRACH portion of a random access message may be transmitted in an RO 405 and a PUSCH portion of the random access message may be transmitted in an associated PO 415 (e.g., single-RO-to-single-PO). For example, an RO 405-a may be associated with, or mapped to, a PO 415-a. For a two-step random access procedure with beam sweeping, in order to support PRACH repetitions, a set of ROs 410 may be mapped to a PO 415. That is, since the UE may transmit the PUSCH portion of the random access message once, the set of ROs 410 may be associated with one PO 415. For example, a set of ROs 410-a may be mapped to a PO 415-c. In some cases, a network entity may indicate the possible ROs 405 and, additionally, or alternatively, the possible POs 415 via system information (e.g., rach-ConfigCommonTwoStepRA). The network entity may also indicate, via the system information, how the possible ROs 405 may map to the possible POs 415. For example, the ROs 405-a and 405-b may map to the POs 415-a and 415-b, respectively, and may be used for a two-step random access procedure without repetition. The set of ROs 410-a and the set of ROs 410-b may be mapped to the POs 415-c and 415-d, respectively (e.g., set-of-ROs-to-single-PO). For example, the UE may transmit four repetitions of the PRACH portion of the random access message via the set of ROs 410-a using narrow beams, where each RO 405 within the set of ROs 410-a may be associated with a narrow beam. The UE may transmit the PUSCH portion of the random access message via the PO 415-c using a wide beam (e.g., initial beam). In some cases, the UE may randomly determine a set of ROs 410 (and the associated PO 415) to use for transmission of the random access message. In other cases, the network entity may indicate which set of ROs 410 the UE may use. In other cases, the UE may choose a set of ROs 410 based on some criteria.

The block diagram 400 is an illustrative example of a possible mapping between ROs 405 and POs 415, and many other mappings between ROs 405 and POs 415 may be implemented. For example, there may be many sets of ROs 410, only one set of ROs 410, no single ROs 405 that map to single POs 415 (e.g., RO 405-a and PO 415-b), many single ROs 405 that map to single POs 415, or any combination thereof.

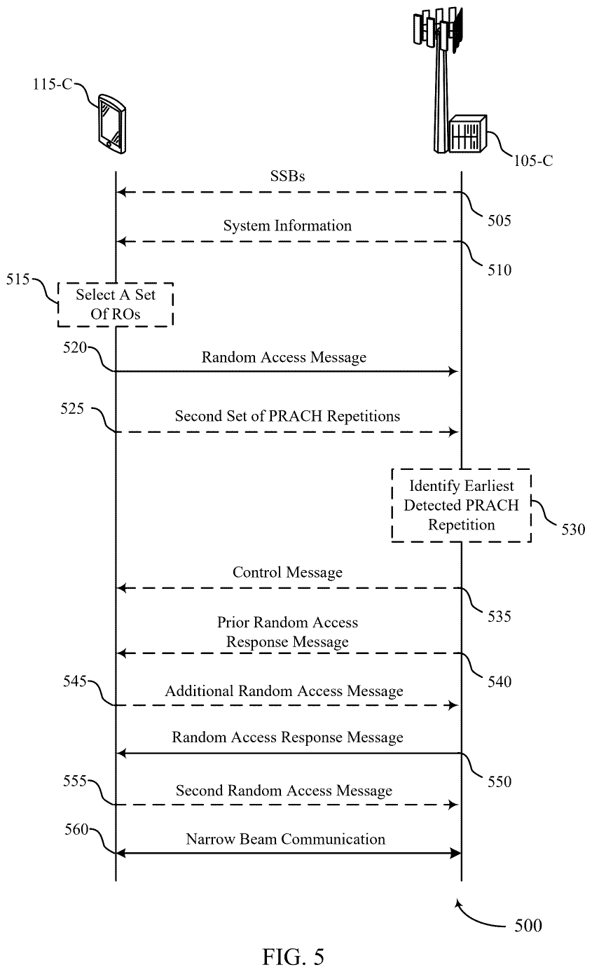

FIG. 5 shows an example of a process flow 500 that supports early beam refinement via random access message repetition for a two-step random access procedure in accordance with one or more aspects of the present disclosure. The process flow 500 may implement, or be implemented by, aspects of the wireless communications systems 100 and 200, the timing diagram 300, and the block diagram 400. For example, the timing diagram 300 may include one or more network entities 105 and one or more UEs 115, including at least the network entity 105-c and UE 115-c, which may be examples of corresponding devices as described herein, including with reference to FIG. 1-3. The techniques described herein in the context of the process flow 500 may support a UE 115-a performing a beam sweep during two-step random access procedure via repetition of a PRACH portion of a random access message.

In some implementations, at 505, the UE 115-c may receive one or more SSBs, where a wide beam may be associated with an SSB of the one or more SSBs. In some cases, each SSB may be associated with a wide beam.

In some implementations, at 510, the UE 115-c may receive, and the network entity 105-c may transmit, system information that may indicate a beam sweep configuration. In some cases, the UE 115-c may transmit a set of repetitions of a PRACH portion of a random access response message in accordance with the beam sweep configuration, as described further at 520. In some cases, the beam sweep configuration may indicate a quantity of repetitions of the PRACH portion of the random access message, a threshold quantity of random access message retransmissions, a fallback random access message transmission configuration, or any combination thereof. In some cases, the beam sweep configuration may indicate multiple sets of ROs, where the UE 115-c may transmit the multiple repetitions of the PRACH portion of the random access message via a set of ROs from among the multiple sets of ROs. In some examples, the beam sweep configuration may indicate a plurality of POs, where each PO may be associated with a respective set of ROs among the multiple sets of ROs. The UE 115-c may transmit the PUSCH portion of the random access message via a PO associated with the set of ROs.

In some implementations, at 515, the UE 115-c may select the set of ROs from among the multiple sets of ROs. In some cases, selecting the set of ROs may include selecting an associated PO. The UE 115-c may transmit the random access message (e.g., at 520) in accordance with selecting the set of ROs.

At 520, the UE 115-c may transmit, and the network entity 105-c may receive, a random access message that may include a PRACH portion and a PUSCH portion. Transmitting the random access message may include transmitting multiple repetitions of the PRACH portion of the random access message via multiple narrow beams associated with (e.g., spatially included within) a wide beam, and transmitting the PUSCH portion of the random access message via the wide beam. In some cases, the wide beam may be the wide beam associated with the SSB at 505. In some cases, the UE 115-b may transmit the multiple repetitions of the PRACH portion of the random access message by transmitting each repetition of the multiple repetitions in accordance with a transmission power, where the transmission power may be in accordance with a measured path loss associated with the SSB at 505. That is, the UE 115-b may transmit each PRACH repetition with a same transmission power. In some cases, the UE 115-b may transmit the multiple repetitions of the PRACH portion of the random access message in accordance with an RSRP associated with the SSB at 505 being greater than or equal to a first threshold, being less than a second threshold, or both. That is, implementing the two-step random access procedure with beam sweeping may be dependent on an RSRP of the SSB at 505. In some cases, the UE 115-c may transmit a plurality of repetitions of a PRACH portion of a random access response message in accordance with the beam sweep configuration, as described at 510. In some cases, the UE 115-c may transmit each of the multiple repetitions of the PRACH portion of the random access message using a common preamble.

In some implementations, at 525, the UE 115-c may transmit a second set of multiple repetitions of the PRACH portion of the random access message via the wide beam in accordance with a RSRP associated with the SSB failing to satisfy a first threshold. That is, the UE 115-c may default to using a two-step random access procedure with wide beam repetition, rather than beam sweeping.

In some implementations, at 530, the network entity 105-c may identify, for an earliest detected repetition of the PRACH portion of the random access message from among the multiple repetitions of the PRACH portion of the random access message, a RNTI. The RNTI may be associated with a RO corresponding to the earliest detected repetition.

In some implementations, at 535, the network entity 105-c may transmit a control message that may schedule the random access response message. The control message may be associated with the RNTI at 530 in accordance with (e.g., based on) the RNTI being associated with the RO corresponding to the earliest detected repetition.

In some implementations, at 540, the network entity 105-c may transmit a prior random access response message. The UE 115-c may fail to receive or decode the prior random access message at 540.

In some implementations, at 545, the UE 115-c may transmit, and the network entity 105-c may receive, at least one additional random access message prior to receiving a random access response message at 550. The UE 115-c may transmit the at least one additional random access message in accordance with a failure of the UE 115-c to receive or decode the prior random access response message at 540. The UE 115-c may transmit each additional random access message by transmitting multiple repetitions of a PRACH portion of the additional random access message via the multiple narrow beams associated with the wide beam, and transmitting a PUSCH portion of the additional random access message via the wide beam. That is, the UE 115-c may retransmit the random access message at 520. In some cases, the UE 115-c may transmit one or more additional random access messages until a threshold quantity of random access messages may be satisfied. That is, the UE 115-c may continue to fail to receive or decode random access response messages form the network entity 105-c, and may retransmit a limited quantity of random access messages using the PRACH portion repetition.

At 550, the UE 115-c may receive, and the network entity 105-c may transmit, a random access response message, where the random access response message may indicate a narrow beam from among the multiple narrow beams in accordance with transmitting the plurality of repetitions of the PRACH portion of the random access message at 520.

In some implementations, at 555, the UE 115-c may transmit a second random access message via the narrow beam, the second random access message including a PUSCH message. For example, the network entity 105-c may successfully receive and decode the repetitions of the PRACH portion of the random access message at 520, but may fail to successfully receive and decode the PUSCH portion of the random access message at 520. The UE 115-c may retransmit the PUSCH portion of the random access message at 555. In some cases, the random access response message at 550 may schedule the second random access message at 555, and may indicate for the UE 115-c to use the narrow beam for the transmission. In other cases, the random access response message may indicate for the UE 115-c to transmit the second random access message via the wide beam. That is, the UE 115-c may default to a four-step random access procedure at 555.

At 560, the UE 115-c and the network entity 105-c may communicate (e.g., transmit or receive signaling) via the narrow beam in accordance with receiving the random access response message at 545. In some cases, the UE 115-c may transmit, and the network entity 105-c may receive a feedback message, via the narrow beam, indicating successful reception of the random access response message at 550.

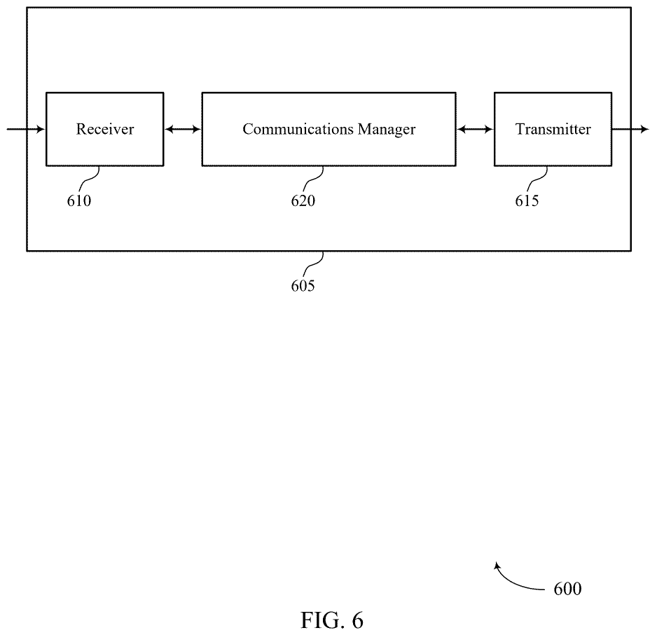

FIG. 6 shows a block diagram 600 of a device 605 that supports early beam refinement via random access message repetition for a two-step random access procedure in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to early beam refinement via random access message repetition for a two-step random access procedure). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to early beam refinement via random access message repetition for a two-step random access procedure). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations or components thereof may be examples of means for performing various aspects of early beam refinement via random access message repetition for a two-step random access procedure as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor (e.g., referred to as a processor-executable code). If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. For example, the communications manager 620 is capable of, configured to, or operable to support a means for transmitting a random access message that includes a PRACH portion and a PUSCH portion. In some examples, to transmit the random access message, the communications manager 620 may be configured as or otherwise support a means for transmitting a set of multiple repetitions of the PRACH portion of the random access message via a set of multiple narrow beams associated with a wide beam and transmitting the PUSCH portion of the random access message via the wide beam. The communications manager 620 is capable of, configured to, or operable to support a means for receiving a random access response message, where the random access response message indicates a narrow beam from among the set of multiple narrow beams in accordance with transmitting the set of multiple repetitions of the PRACH portion of the random access message. The communications manager 620 is capable of, configured to, or operable to support a means for communicating via the narrow beam in accordance with receiving the random access response message.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for reduced latency and more efficient utilization of communication resources.

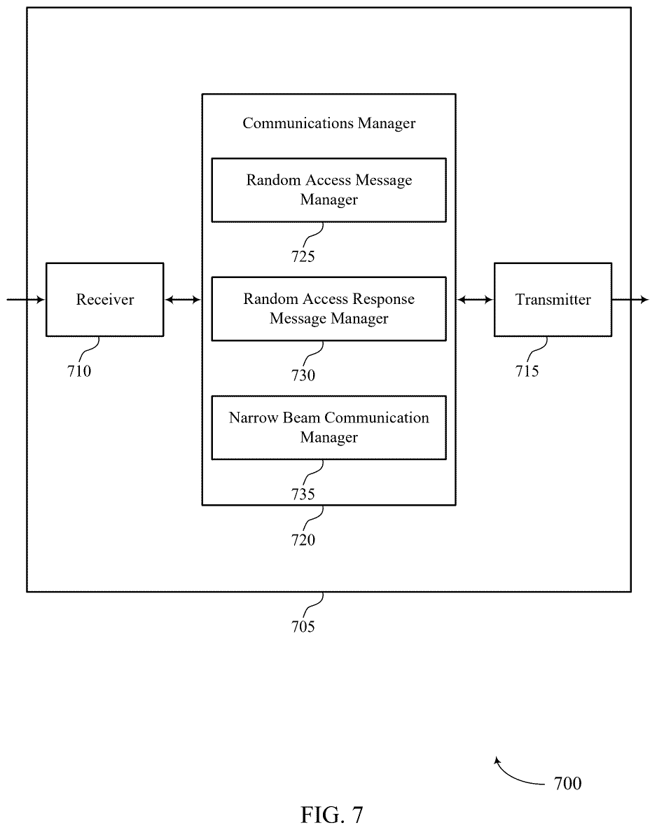

FIG. 7 shows a block diagram 700 of a device 705 that supports early beam refinement via random access message repetition for a two-step random access procedure in accordance with one or more aspects of the present disclosure. The device 705 may be an example of aspects of a device 605 or a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to early beam refinement via random access message repetition for a two-step random access procedure). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to early beam refinement via random access message repetition for a two-step random access procedure). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of early beam refinement via random access message repetition for a two-step random access procedure as described herein. For example, the communications manager 720 may include a random access message manager 725, a random access response message manager 730, a narrow beam communication manager 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. The random access message manager 725 is capable of, configured to, or operable to support a means for transmitting a random access message that includes a PRACH portion and a PUSCH portion. In some examples, to transmit the random access message, the random access message manager 725 may be configured as or otherwise support a means for transmitting a set of multiple repetitions of the PRACH portion of the random access message via a set of multiple narrow beams associated with a wide beam and the random access message manager 725 may be configured as or otherwise support a means for transmitting the PUSCH portion of the random access message via the wide beam. The random access response message manager 730 is capable of, configured to, or operable to support a means for receiving a random access response message, where the random access response message indicates a narrow beam from among the set of multiple narrow beams in accordance with transmitting the set of multiple repetitions of the PRACH portion of the random access message. The narrow beam communication manager 735 is capable of, configured to, or operable to support a means for communicating via the narrow beam in accordance with receiving the random access response message.

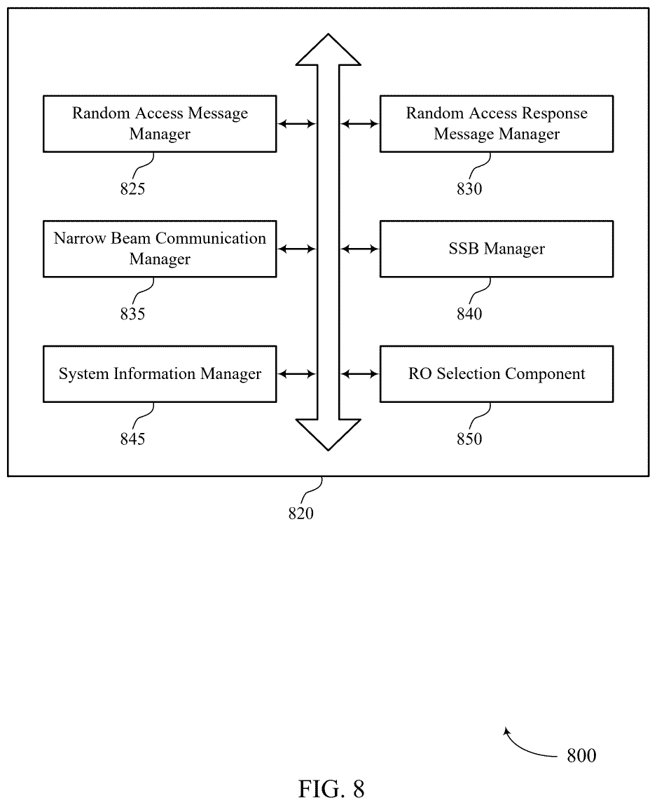

FIG. 8 shows a block diagram 800 of a communications manager 820 that supports early beam refinement via random access message repetition for a two-step random access procedure in accordance with one or more aspects of the present disclosure. The communications manager 820 may be an example of aspects of a communications manager 620, a communications manager 720, or both, as described herein. The communications manager 820, or various components thereof, may be an example of means for performing various aspects of early beam refinement via random access message repetition for a two-step random access procedure as described herein. For example, the communications manager 820 may include a random access message manager 825, a random access response message manager 830, a narrow beam communication manager 835, an SSB manager 840, a system information manager 845, a RO selection component 850, or any combination thereof. Each of these components, or components or subcomponents thereof (e.g., one or more processors, one or more memories), may communicate, directly or indirectly, with one another (e.g., via one or more buses).

The communications manager 820 may support wireless communications in accordance with examples as disclosed herein. The random access message manager 825 is capable of, configured to, or operable to support a means for transmitting a random access message that includes a PRACH portion and a PUSCH portion. In some examples, to transmit the random access message, the random access message manager 825 is capable of, configured to, or operable to support a means for transmitting a set of multiple repetitions of the PRACH portion of the random access message via a set of multiple narrow beams associated with a wide beam and the random access message manager 825 is capable of, configured to, or operable to support a means for transmitting the PUSCH portion of the random access message via the wide beam. The random access response message manager 830 is capable of, configured to, or operable to support a means for receiving a random access response message, where the random access response message indicates a narrow beam from among the set of multiple narrow beams in accordance with transmitting the set of multiple repetitions of the PRACH portion of the random access message. The narrow beam communication manager 835 is capable of, configured to, or operable to support a means for communicating via the narrow beam in accordance with receiving the random access response message.

In some examples, the SSB manager 840 is capable of, configured to, or operable to support a means for receiving one or more SSBs, where the wide beam is associated with a SSB of the one or more SSBs.

In some examples, to support transmitting the set of multiple repetitions of the PRACH portion of the random access message, the random access message manager 825 is capable of, configured to, or operable to support a means for transmitting each repetition of the set of multiple repetitions of the PRACH portion of the random access message in accordance with a transmission power, where the transmission power is in accordance with a measured path loss associated with the SSB.

In some examples, transmitting the set of multiple repetitions of the PRACH portion of the random access message is in accordance with a RSRP associated with the SSB being greater than or equal to a first threshold, being less than a second threshold, or both.

In some examples, the random access message manager 825 is capable of, configured to, or operable to support a means for transmitting a second set of multiple repetitions of the PRACH portion of the random access message via the wide beam in accordance with a RSRP associated with the SSB failing to satisfy a first threshold.

In some examples, to support communicating via the narrow beam, the narrow beam communication manager 835 is capable of, configured to, or operable to support a means for transmitting, via the narrow beam, a feedback message indicating successful reception of the random access response message.

In some examples, to support transmitting the set of multiple repetitions of the PRACH portion of the random access message, the random access message manager 825 is capable of, configured to, or operable to support a means for transmitting each of the set of multiple repetitions of the PRACH portion of the random access message using a common preamble.

In some examples, to support communicating via the narrow beam, the narrow beam communication manager 835 is capable of, configured to, or operable to support a means for transmitting a second random access message via the narrow beam, the second random access message including a PUSCH message.

In some examples, the random access message manager 825 is capable of, configured to, or operable to support a means for transmitting, prior to receiving the random access response message, at least one additional random access message in accordance with a failure to receive or decode a prior random access response message. In some examples, to transmit each additional random access message, the random access message manager 825 is capable of, configured to, or operable to support a means for transmitting a set of multiple repetitions of a PRACH portion of the additional random access message via the set of multiple narrow beams associated with the wide beam and the random access message manager 825 is capable of, configured to, or operable to support a means for transmitting a PUSCH portion of the additional random access message via the wide beam.

In some examples, to support transmitting the at least one additional random access message, the random access message manager 825 is capable of, configured to, or operable to support a means for transmitting one or more additional random access messages until a threshold quantity of random access messages is satisfied.

In some examples, the system information manager 845 is capable of, configured to, or operable to support a means for receiving system information indicating a beam sweep configuration, where transmitting the set of multiple repetitions of the PRACH portion of the random access response message is in accordance with the beam sweep configuration.

In some examples, the beam sweep configuration indicates a quantity of repetitions of the PRACH portion of the random access message, a threshold quantity of random access message retransmissions, a fallback random access message transmission configuration, or any combination thereof.

In some examples, the beam sweep configuration indicates a set of multiple sets of ROs. In some examples, transmitting the set of multiple repetitions of the PRACH portion of the random access message is via a set of ROs from among the set of multiple sets of ROs. In some examples, the beam sweep configuration indicates a set of multiple POs. In some examples, each PO is associated with a respective set of ROs among the set of multiple sets of ROs. In some examples, transmitting the PUSCH portion of the random access message is via a PO associated with the set of ROs.

In some examples, the RO selection component 850 is capable of, configured to, or operable to support a means for selecting, by the UE, the set of ROs from among the set of multiple sets of ROs.

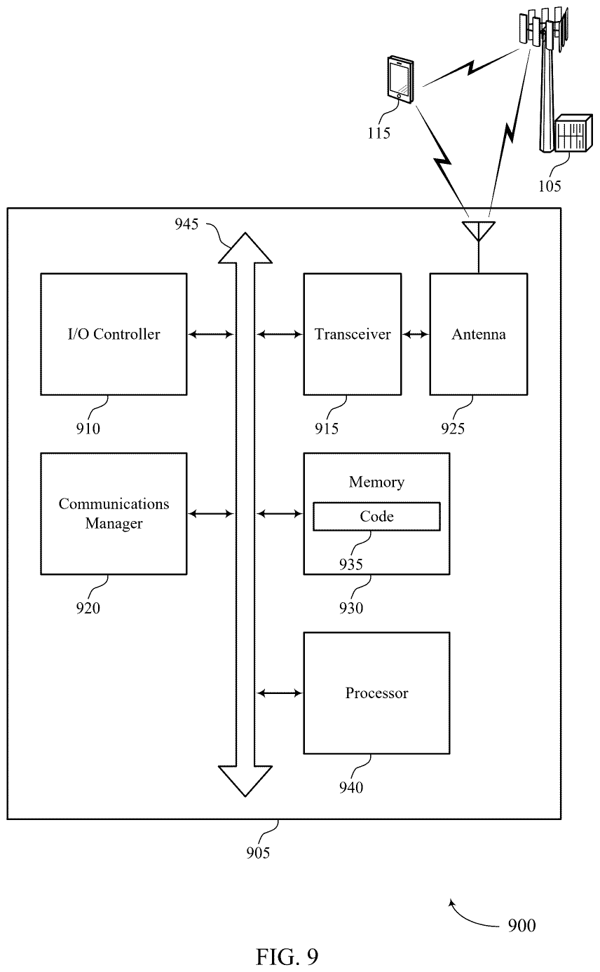

FIG. 9 shows a diagram of a system 900 including a device 905 that supports early beam refinement via random access message repetition for a two-step random access procedure in accordance with one or more aspects of the present disclosure. The device 905 may be an example of or include components of a device 605, a device 705, or a UE 115 as described herein. The device 905 may communicate (e.g., wirelessly) with one or more other devices (e.g., network entities 105, UEs 115, or a combination thereof). The device 905 may include components for bi-directional voice and data communications including components for transmitting and receiving communications, such as a communications manager 920, an input/output (I/O) controller, such as an I/O controller 910, a transceiver 915, one or more antennas 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna. However, in some other cases, the device 905 may have more than one antenna, which may be capable of concurrently transmitting or receiving multiple wireless transmissions. The transceiver 915 may communicate bi-directionally via the one or more antennas 925 using wired or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable, or processor-executable code, such as the code 935. The code 935 may include instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may include, among other things, a basic I/O system (BIOS) which may control basic hardware or software operation such as the interaction with peripheral components or devices.

The at least one processor 940 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting early beam refinement via random access message repetition for a two-step random access procedure). For example, the device 905 or a component of the device 905 may include at least one processor 940 and at least one memory 930 coupled with or to the at least one processor 940, the at least one processor 940 and the at least one memory 930 configured to perform various functions described herein.

In some examples, the at least one processor 940 may include multiple processors and the at least one memory 930 may include multiple memories. One or more of the multiple processors may be coupled with one or more of the multiple memories, which may, individually or collectively, be configured to perform various functions described herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code 935 (e.g., processor-executable code) stored in the at least one memory 930 or otherwise, to perform one or more of the functions described herein.

The communications manager 920 may support wireless communications in accordance with examples as disclosed herein. For example, the communications manager 920 is capable of, configured to, or operable to support a means for transmitting a random access message that includes a PRACH portion and a PUSCH portion. In some examples, to transmit the random access message, the communications manager 920 may be configured as or otherwise support a means for transmitting a set of multiple repetitions of the PRACH portion of the random access message via a set of multiple narrow beams associated with a wide beam and transmitting the PUSCH portion of the random access message via the wide beam. The communications manager 920 is capable of, configured to, or operable to support a means for receiving a random access response message, where the random access response message indicates a narrow beam from among the set of multiple narrow beams in accordance with transmitting the set of multiple repetitions of the PRACH portion of the random access message. The communications manager 920 is capable of, configured to, or operable to support a means for communicating via the narrow beam in accordance with receiving the random access response message.

By including or configuring the communications manager 920 in accordance with examples as described herein, the device 905 may support techniques for improved communication reliability, reduced latency, more efficient utilization of communication resources, and improved utilization of processing capability.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of early beam refinement via random access message repetition for a two-step random access procedure as described herein, or the at least one processor 940 and the at least one memory 930 may be otherwise configured to, individually or collectively, perform or support such operations.

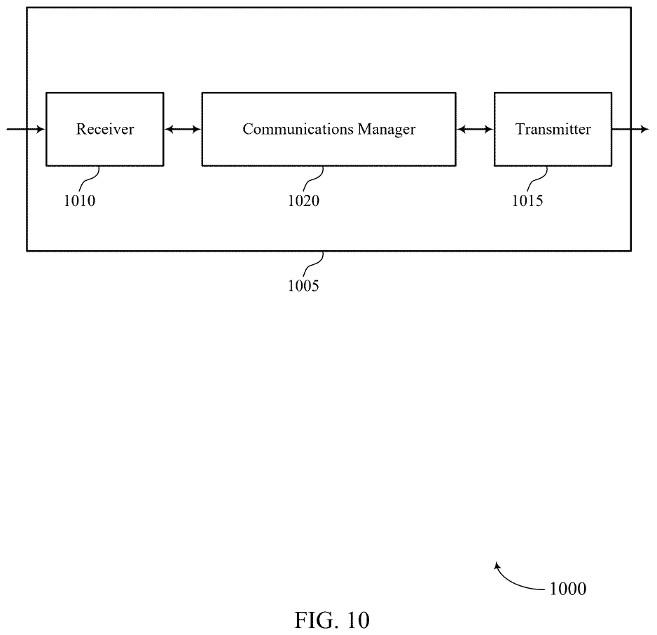

FIG. 10 shows a block diagram 1000 of a device 1005 that supports early beam refinement via random access message repetition for a two-step random access procedure in accordance with one or more aspects of the present disclosure. The device 1005 may be an example of aspects of a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to, individually or collectively, support or enable the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations or components thereof may be examples of means for performing various aspects of early beam refinement via random access message repetition for a two-step random access procedure as described herein. For example, the communications manager 1020, the receiver 1010, the transmitter 1015, or various combinations or components thereof may be capable of performing one or more of the functions described herein.

In some examples, the communications manager 1020, the receiver 1010, the transmitter 1015, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1020, the receiver 1010, the transmitter 1015, or various combinations or components thereof may be implemented in code (e.g., as communications management software or firmware) executed by at least one processor (e.g., referred to as a processor-executable code). If implemented in code executed by at least one processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. For example, the communications manager 1020 is capable of, configured to, or operable to support a means for receiving a random access message that includes a PRACH portion and a PUSCH portion. In some examples, to receive the random access message, the communications manager 1020 may be configured as or otherwise support a means for receiving a set of multiple repetitions of the PRACH portion of the random access message via a set of multiple narrow beams associated with a wide beam and receiving the PUSCH portion of the random access message via the wide beam. The communications manager 1020 is capable of, configured to, or operable to support a means for transmitting a random access response message, where the random access response message indicates a narrow beam from among the set of multiple narrow beams in accordance with receiving the set of multiple repetitions of the PRACH portion of the random access message. The communications manager 1020 is capable of, configured to, or operable to support a means for communicating via the narrow beam in accordance with transmitting the random access response message.

By including or configuring the communications manager 1020 in accordance with examples as described herein, the device 1005 (e.g., at least one processor controlling or otherwise coupled with the receiver 1010, the transmitter 1015, the communications manager 1020, or a combination thereof) may support techniques for reduced latency and more efficient utilization of communication resources.

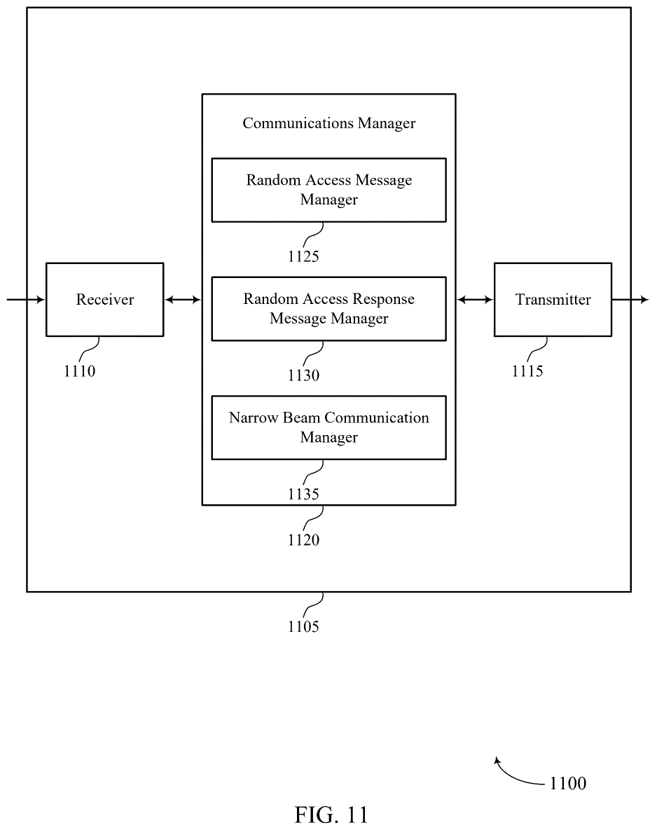

FIG. 11 shows a block diagram 1100 of a device 1105 that supports early beam refinement via random access message repetition for a two-step random access procedure in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to support the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of early beam refinement via random access message repetition for a two-step random access procedure as described herein. For example, the communications manager 1120 may include a random access message manager 1125, a random access response message manager 1130, a narrow beam communication manager 1135, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. The random access message manager 1125 is capable of, configured to, or operable to support a means for receiving a random access message that includes a PRACH portion and a PUSCH portion. In some examples, to receive the random access message, the random access message manager 1125 may be configured as or otherwise support a means for receiving a set of multiple repetitions of the PRACH portion of the random access message via a set of multiple narrow beams associated with a wide beam and the random access message manager 1125 may be configured as or otherwise support a means for receiving the PUSCH portion of the random access message via the wide beam. The random access response message manager 1130 is capable of, configured to, or operable to support a means for transmitting a random access response message, where the random access response message indicates a narrow beam from among the set of multiple narrow beams in accordance with receiving the set of multiple repetitions of the PRACH portion of the random access message. The narrow beam communication manager 1135 is capable of, configured to, or operable to support a means for communicating via the narrow beam in accordance with transmitting the random access response message.

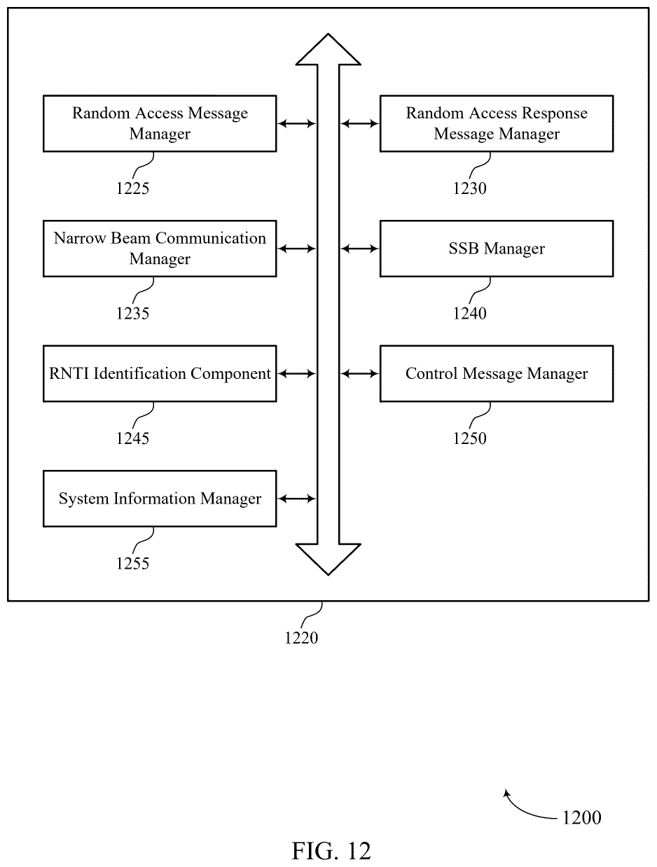

FIG. 12 shows a block diagram 1200 of a communications manager 1220 that supports early beam refinement via random access message repetition for a two-step random access procedure in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of early beam refinement via random access message repetition for a two-step random access procedure as described herein. For example, the communications manager 1220 may include a random access message manager 1225, a random access response message manager 1230, a narrow beam communication manager 1235, an SSB manager 1240, an RNTI identification component 1245, a control message manager 1250, a system information manager 1255, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communications in accordance with examples as disclosed herein. The random access message manager 1225 is capable of, configured to, or operable to support a means for receiving a random access message that includes a PRACH portion and a PUSCH portion. In some examples, to receive the random access message, the random access message manager 1225 is capable of, configured to, or operable to support a means for receiving a set of multiple repetitions of the PRACH portion of the random access message via a set of multiple narrow beams associated with a wide beam and the random access message manager 1225 is capable of, configured to, or operable to support a means for receiving the PUSCH portion of the random access message via the wide beam. The random access response message manager 1230 is capable of, configured to, or operable to support a means for transmitting a random access response message, where the random access response message indicates a narrow beam from among the set of multiple narrow beams in accordance with receiving the set of multiple repetitions of the PRACH portion of the random access message. The narrow beam communication manager 1235 is capable of, configured to, or operable to support a means for communicating via the narrow beam in accordance with transmitting the random access response message.

In some examples, the SSB manager 1240 is capable of, configured to, or operable to support a means for transmitting one or more SSBs, where the wide beam is associated with a SSB of the one or more SSBs.

In some examples, to support receiving the set of multiple repetitions of the PRACH portion of the random access message, the random access message manager 1225 is capable of, configured to, or operable to support a means for receiving each repetition of the set of multiple repetitions of the PRACH portion of the random access message in accordance with a transmission power, where the transmission power is in accordance with transmitting the SSB.

In some examples, receiving the set of multiple repetitions of the PRACH portion of the random access message is in accordance with a RSRP associated with the SSB being greater than or equal to a first threshold, being less than a second threshold, or both.

In some examples, the random access message manager 1225 is capable of, configured to, or operable to support a means for receiving a second set of multiple repetitions of the PRACH portion of the random access message via the wide beam in accordance with a RSRP associated with the SSB failing to satisfy a first threshold.

In some examples, to support communicating via the narrow beam, the narrow beam communication manager 1235 is capable of, configured to, or operable to support a means for receiving, via the narrow beam, a feedback message indicating successful reception of the random access response message.

In some examples, the RNTI identification component 1245 is capable of, configured to, or operable to support a means for identifying, for an earliest detected repetition of the PRACH portion of the random access message from among the set of multiple repetitions of the PRACH portion of the random access message, a radio network temporary identifier that is associated with a RO corresponding to the earliest detected repetition. In some examples, the control message manager 1250 is capable of, configured to, or operable to support a means for transmitting a control message that schedules the random access response message, where the control message is associated with the radio network temporary identifier in accordance with the radio network temporary identifier being associated with the RO corresponding to the earliest detected repetition.

In some examples, to support receiving the set of multiple repetitions of the PRACH portion of the random access message, the random access message manager 1225 is capable of, configured to, or operable to support a means for receiving each of the set of multiple repetitions of the PRACH portion of the random access message using a common preamble.

In some examples, to support communicating via the narrow beam, the narrow beam communication manager 1235 is capable of, configured to, or operable to support a means for receiving a second random access message via the narrow beam, the second random access message including a PUSCH message.

In some examples, the random access message manager 1225 is capable of, configured to, or operable to support a means for receiving, prior to transmitting the random access response message, at least one additional random access message in accordance with a reception or decoding failure for a prior random access response message. In some examples, to receive each additional random access message, the random access message manager 1225 is capable of, configured to, or operable to support a means for receiving a set of multiple repetitions of a PRACH portion of the additional random access message via the set of multiple narrow beams associated with the wide beam and the random access message manager 1225 is capable of, configured to, or operable to support a means for receiving a PUSCH portion of the additional random access message via the wide beam.

In some examples, to support receiving the at least one additional random access message, the random access message manager 1225 is capable of, configured to, or operable to support a means for receiving one or more additional random access messages until a threshold quantity of random access messages is satisfied.

In some examples, the system information manager 1255 is capable of, configured to, or operable to support a means for transmitting system information indicating a beam sweep configuration, where transmitting the set of multiple repetitions of the PRACH portion of the random access response message is in accordance with the beam sweep configuration.

In some examples, the beam sweep configuration indicates a quantity of repetitions of the PRACH portion of the random access message, a threshold quantity of random access message retransmissions, a fallback random access message transmission configuration, or any combination thereof.

In some examples, receiving the set of multiple repetitions of the PRACH portion of the random access message is via a set of ROs from among the set of multiple sets of ROs, and where the beam sweep configuration indicates a set of multiple POs, where each PO is associated with a respective set of ROs among the set of multiple sets of ROs, and where receiving the PUSCH portion of the random access message is via a PO associated with the set of ROs.

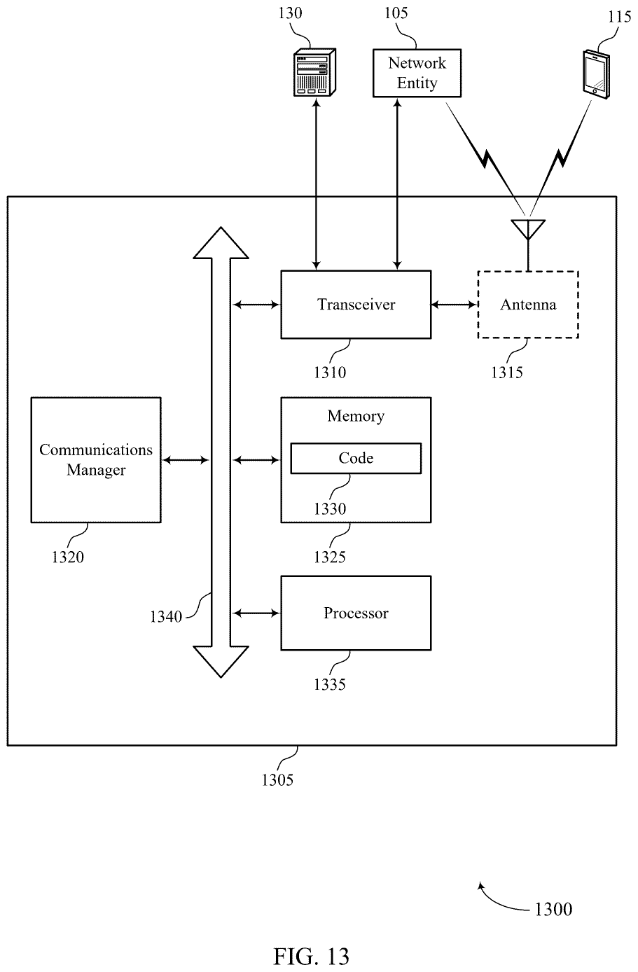

FIG. 13 shows a diagram of a system 1300 including a device 1305 that supports early beam refinement via random access message repetition for a two-step random access procedure in accordance with one or more aspects of the present disclosure. The device 1305 may be an example of or include components of a device 1005, a device 1105, or a network entity 105 as described herein. The device 1305 may communicate with other network devices or network equipment such as one or more of the network entities 105, UEs 115, or any combination thereof. The communications may include communications over one or more wired interfaces, over one or more wireless interfaces, or any combination thereof. The device 1305 may include components that support outputting and obtaining communications, such as a communications manager 1320, a transceiver 1310, one or more antennas 1315, at least one memory 1325, code 1330, and at least one processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or one or more memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or one or more memory components (e.g., the at least one processor 1335, the at least one memory 1325, or both), may be included in a chip or chip assembly that is installed in the device 1305. In some examples, the transceiver 1310 may be operable to support communications via one or more communications links (e.g., communication link(s) 125, backhaul communication link(s) 120, a midhaul communication link 162, a fronthaul communication link 168).

The at least one memory 1325 may include RAM, ROM, or any combination thereof. The at least one memory 1325 may store computer-readable, computer-executable, or processor-executable code, such as the code 1330. The code 1330 may include instructions that, when executed by one or more of the at least one processor 1335, cause the device 1305 to perform various functions described herein. The code 1330 may be stored in a non-transitory computer-readable medium such as system memory or another type of memory. In some cases, the code 1330 may not be directly executable by a processor of the at least one processor 1335 but may cause a computer (e.g., when compiled and executed) to perform functions described herein. In some cases, the at least one memory 1325 may include, among other things, a BIOS which may control basic hardware or software operation such as the interaction with peripheral components or devices. In some examples, the at least one processor 1335 may include multiple processors and the at least one memory 1325 may include multiple memories. One or more of the multiple processors may be coupled with one or more of the multiple memories which may, individually or collectively, be configured to perform various functions herein (for example, as part of a processing system).

The at least one processor 1335 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1335 may be configured to operate a memory array using a memory controller. In some other cases, a memory controller may be integrated into one or more of the at least one processor 1335. The at least one processor 1335 may be configured to execute computer-readable instructions stored in a memory (e.g., one or more of the at least one memory 1325) to cause the device 1305 to perform various functions (e.g., functions or tasks supporting early beam refinement via random access message repetition for a two-step random access procedure). For example, the device 1305 or a component of the device 1305 may include at least one processor 1335 and at least one memory 1325 coupled with one or more of the at least one processor 1335, the at least one processor 1335 and the at least one memory 1325 configured to perform various functions described herein. The at least one processor 1335 may be an example of a cloud-computing platform (e.g., one or more physical nodes and supporting software such as operating systems, virtual machines, or container instances) that may host the functions (e.g., by executing code 1330) to perform the functions of the device 1305. The at least one processor 1335 may be any one or more suitable processors capable of executing scripts or instructions of one or more software programs stored in the device 1305 (such as within one or more of the at least one memory 1325).

In some examples, the at least one processor 1335 may include multiple processors and the at least one memory 1325 may include multiple memories. One or more of the multiple processors may be coupled with one or more of the multiple memories, which may, individually or collectively, be configured to perform various functions herein. In some examples, the at least one processor 1335 may be a component of a processing system, which may refer to a system (such as a series) of machines, circuitry (including, for example, one or both of processor circuitry (which may include the at least one processor 1335) and memory circuitry (which may include the at least one memory 1325)), or components, that receives or obtains inputs and processes the inputs to produce, generate, or obtain a set of outputs. The processing system may be configured to perform one or more of the functions described herein. For example, the at least one processor 1335 or a processing system including the at least one processor 1335 may be configured to, configurable to, or operable to cause the device 1305 to perform one or more of the functions described herein. Further, as described herein, being “configured to,” being “configurable to,” and being “operable to” may be used interchangeably and may be associated with a capability, when executing code stored in the at least one memory 1325 or otherwise, to perform one or more of the functions described herein.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the at least one memory 1325, the code 1330, and the at least one processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with one or more other network entities 105, and may include a controller or scheduler for controlling communications with UEs 115 (e.g., in cooperation with the one or more other network devices). In some examples, the communications manager 1320 may support an X2 interface within an LTE/LTE-A wireless communications network technology to provide communication between network entities 105.

The communications manager 1320 may support wireless communications in accordance with examples as disclosed herein. For example, the communications manager 1320 is capable of, configured to, or operable to support a means for receiving a random access message that includes a PRACH portion and a PUSCH portion. In some examples, to receive the random access message, the communications manager 1320 may be configured as or otherwise support a means for receiving a set of multiple repetitions of the PRACH portion of the random access message via a set of multiple narrow beams associated with a wide beam and receiving the PUSCH portion of the random access message via the wide beam. The communications manager 1320 is capable of, configured to, or operable to support a means for transmitting a random access response message, where the random access response message indicates a narrow beam from among the set of multiple narrow beams in accordance with receiving the set of multiple repetitions of the PRACH portion of the random access message. The communications manager 1320 is capable of, configured to, or operable to support a means for communicating via the narrow beam in accordance with transmitting the random access response message.

By including or configuring the communications manager 1320 in accordance with examples as described herein, the device 1305 may support techniques for improved communication reliability, reduced latency, more efficient utilization of communication resources, and improved utilization of processing capability.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, one or more of the at least one processor 1335, one or more of the at least one memory 1325, the code 1330, or any combination thereof (for example, by a processing system including at least a portion of the at least one processor 1335, the at least one memory 1325, the code 1330, or any combination thereof). For example, the code 1330 may include instructions executable by one or more of the at least one processor 1335 to cause the device 1305 to perform various aspects of early beam refinement via random access message repetition for a two-step random access procedure as described herein, or the at least one processor 1335 and the at least one memory 1325 may be otherwise configured to, individually or collectively, perform or support such operations.

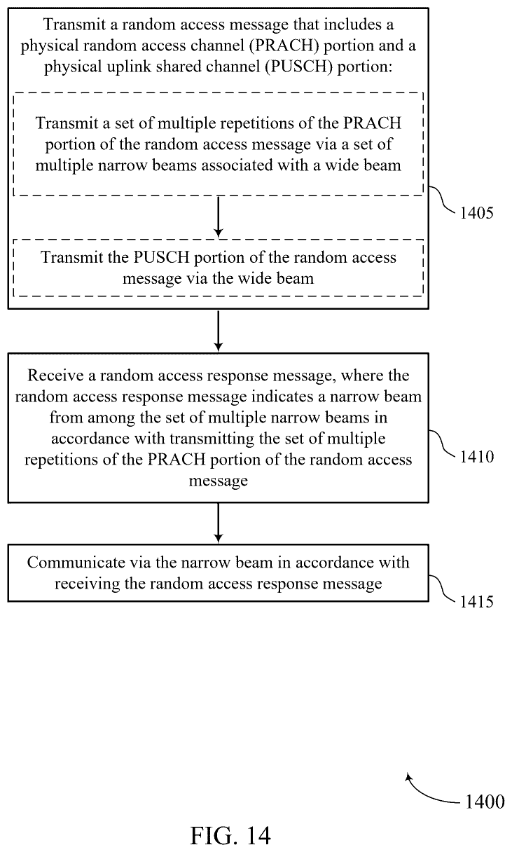

FIG. 14 shows a flowchart illustrating a method 1400 that supports early beam refinement via random access message repetition for a two-step random access procedure in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include transmitting a random access message that includes a PRACH portion and a PUSCH portion. In some examples, transmitting the random access message may include transmitting a set of multiple repetitions of the PRACH portion of the random access message via a set of multiple narrow beams associated with a wide beam and transmitting the PUSCH portion of the random access message via the wide beam. The operations of 1405 may be performed in accordance with examples as disclosed herein. In some examples, aspects of the operations of 1405 may be performed by a random access message manager 825 as described with reference to FIG. 8.

At 1410, the method may include receiving a random access response message, where the random access response message indicates a narrow beam from among the set of multiple narrow beams in accordance with transmitting the set of multiple repetitions of the PRACH portion of the random access message. The operations of 1410 may be performed in accordance with examples as disclosed herein. In some examples, aspects of the operations of 1410 may be performed by a random access response message manager 830 as described with reference to FIG. 8.

At 1415, the method may include communicating via the narrow beam in accordance with receiving the random access response message. The operations of 1415 may be performed in accordance with examples as disclosed herein. In some examples, aspects of the operations of 1415 may be performed by a narrow beam communication manager 835 as described with reference to FIG. 8.

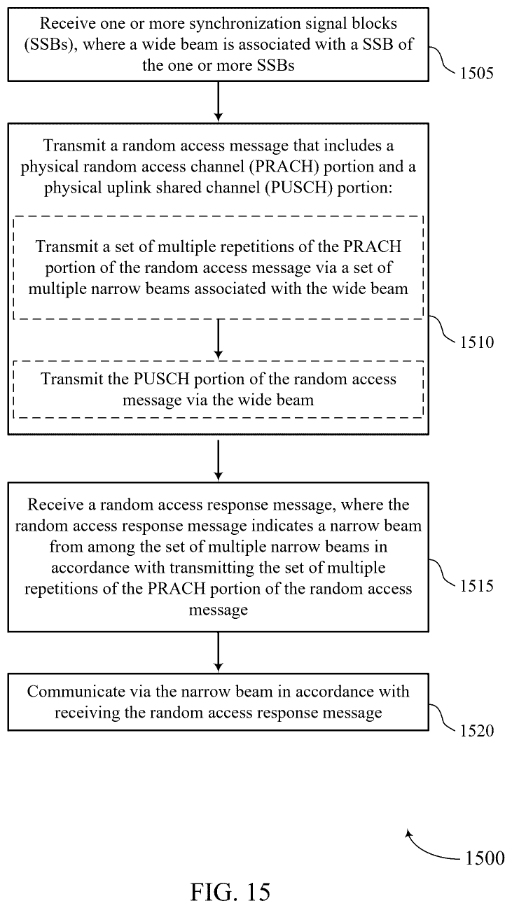

FIG. 15 shows a flowchart illustrating a method 1500 that supports early beam refinement via random access message repetition for a two-step random access procedure in accordance with one or more aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include receiving one or more SSBs, where the wide beam is associated with a SSB of the one or more SSBs. The operations of 1505 may be performed in accordance with examples as disclosed herein. In some examples, aspects of the operations of 1505 may be performed by an SSB manager 840 as described with reference to FIG. 8.

At 1510, the method may include transmitting a random access message that includes a PRACH portion and a PUSCH portion. In some examples, transmitting the random access message may include transmitting a set of multiple repetitions of the PRACH portion of the random access message via a set of multiple narrow beams associated with a wide beam and transmitting the PUSCH portion of the random access message via the wide beam. The operations of 1510 may be performed in accordance with examples as disclosed herein. In some examples, aspects of the operations of 1510 may be performed by a random access message manager 825 as described with reference to FIG. 8.

At 1515, the method may include receiving a random access response message, where the random access response message indicates a narrow beam from among the set of multiple narrow beams in accordance with transmitting the set of multiple repetitions of the PRACH portion of the random access message. The operations of 1515 may be performed in accordance with examples as disclosed herein. In some examples, aspects of the operations of 1515 may be performed by a random access response message manager 830 as described with reference to FIG. 8.

At 1520, the method may include communicating via the narrow beam in accordance with receiving the random access response message. The operations of 1520 may be performed in accordance with examples as disclosed herein. In some examples, aspects of the operations of 1520 may be performed by a narrow beam communication manager 835 as described with reference to FIG. 8.

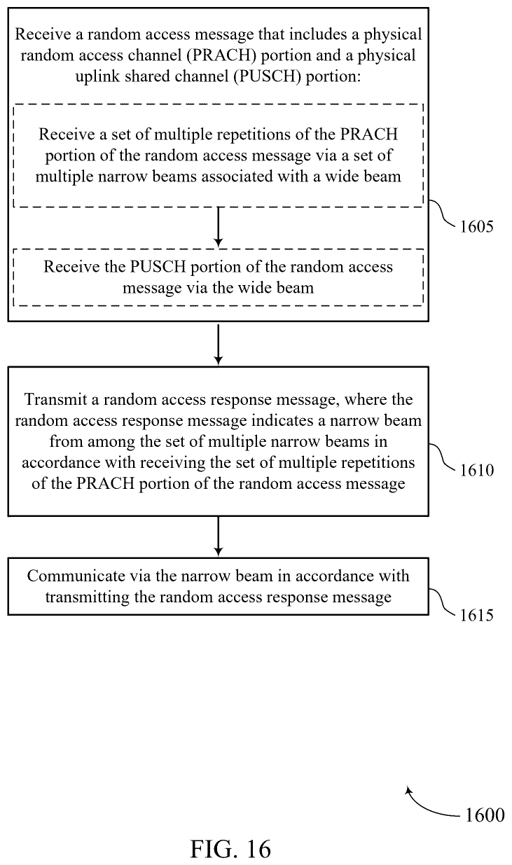

FIG. 16 shows a flowchart illustrating a method 1600 that supports early beam refinement via random access message repetition for a two-step random access procedure in accordance with one or more aspects of the present disclosure. The operations of the method 1600 may be implemented by a network entity or its components as described herein. For example, the operations of the method 1600 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1605, the method may include receiving a random access message that includes a PRACH portion and a PUSCH portion. In some examples, receiving the random access message may include receiving a set of multiple repetitions of the PRACH portion of the random access message via a set of multiple narrow beams associated with a wide beam and receiving the PUSCH portion of the random access message via the wide beam. The operations of 1605 may be performed in accordance with examples as disclosed herein. In some examples, aspects of the operations of 1605 may be performed by a random access message manager 1225 as described with reference to FIG. 12.

At 1610, the method may include transmitting a random access response message, where the random access response message indicates a narrow beam from among the set of multiple narrow beams in accordance with receiving the set of multiple repetitions of the PRACH portion of the random access message. The operations of 1610 may be performed in accordance with examples as disclosed herein. In some examples, aspects of the operations of 1610 may be performed by a random access response message manager 1230 as described with reference to FIG. 12.

At 1615, the method may include communicating via the narrow beam in accordance with transmitting the random access response message. The operations of 1615 may be performed in accordance with examples as disclosed herein. In some examples, aspects of the operations of 1615 may be performed by a narrow beam communication manager 1235 as described with reference to FIG. 12.

The following provides an overview of aspects of the present disclosure:

Aspect 1: A method for wireless communications at a UE, comprising: transmitting a random access message that comprises a PRACH portion and a PUSCH portion, wherein transmitting the random access message comprises: transmitting a plurality of repetitions of the PRACH portion of the random access message via a plurality of narrow beams associated with a wide beam; and transmitting the PUSCH portion of the random access message via the wide beam; receiving a random access response message, wherein the random access response message indicates a narrow beam from among the plurality of narrow beams in accordance with transmitting the plurality of repetitions of the PRACH portion of the random access message; and communicating via the narrow beam in accordance with receiving the random access response message.

Aspect 2: The method of aspect 1, further comprising: receiving one or more SSBs, wherein the wide beam is associated with a SSB of the one or more SSBs.

Aspect 3: The method of aspect 2, wherein transmitting the plurality of repetitions of the PRACH portion of the random access message comprises: transmitting each repetition of the plurality of repetitions of the PRACH portion of the random access message in accordance with a transmission power, wherein the transmission power is in accordance with a measured path loss associated with the SSB.

Aspect 4: The method of any of aspects 2 through 3, wherein transmitting the plurality of repetitions of the PRACH portion of the random access message is in accordance with a RSRP associated with the SSB being greater than or equal to a first threshold, being less than a second threshold, or both.

Aspect 5: The method of any of aspects 2 through 4, further comprising: transmitting a second plurality of repetitions of the PRACH portion of the random access message via the wide beam in accordance with a RSRP associated with the SSB failing to satisfy a first threshold.

Aspect 6: The method of any of aspects 1 through 5, wherein communicating via the narrow beam comprises: transmitting, via the narrow beam, a feedback message indicating successful reception of the random access response message.

Aspect 7: The method of any of aspects 1 through 6, wherein transmitting the plurality of repetitions of the PRACH portion of the random access message comprises: transmitting each of the plurality of repetitions of the PRACH portion of the random access message using a common preamble.

Aspect 8: The method of any of aspects 1 through 7, wherein communicating via the narrow beam comprises: transmitting a second random access message via the narrow beam, the second random access message comprising a PUSCH message.

Aspect 9: The method of any of aspects 1 through 8, further comprising: transmitting, prior to receiving the random access response message, at least one additional random access message in accordance with a failure to receive or decode a prior random access response message, wherein transmitting each additional random access message comprises: transmitting a plurality of repetitions of a PRACH portion of the additional random access message via the plurality of narrow beams associated with the wide beam; and transmitting a PUSCH portion of the additional random access message via the wide beam.

Aspect 10: The method of aspect 9, wherein transmitting the at least one additional random access message comprises: transmitting one or more additional random access messages until a threshold quantity of random access messages is satisfied.

Aspect 11: The method of any of aspects 1 through 10, further comprising: receiving system information indicating a beam sweep configuration, wherein transmitting the plurality of repetitions of the PRACH portion of the random access response message is in accordance with the beam sweep configuration.

Aspect 12: The method of aspect 11, wherein the beam sweep configuration indicates a quantity of repetitions of the PRACH portion of the random access message, a threshold quantity of random access message retransmissions, a fallback random access message transmission configuration, or any combination thereof.

Aspect 13: The method of any of aspects 11 through 12, wherein the beam sweep configuration indicates a plurality of sets of ROs, the one or more processors are individually or collectively operable to execute the code to cause the UE to transmit the plurality of repetitions of the PRACH portion of the random access message via a set of ROs from among the plurality of sets of ROs, and the beam sweep configuration indicates a plurality of POs, each PO is associated with a respective set of ROs among the plurality of sets of ROs, and the one or more processors are individually or collectively operable to execute the code to cause the UE to transmit the PUSCH portion of the random access message via a PO associated with the set of ROs.

Aspect 14: The method of aspect 13, further comprising: selecting, by the UE, the set of ROs from among the plurality of sets of ROs.

Aspect 15: A method for wireless communications at a network entity, comprising: receiving a random access message that comprises a PRACH portion and a PUSCH portion, wherein receiving the random access message comprises: receiving a plurality of repetitions of the PRACH portion of the random access message via a plurality of narrow beams associated with a wide beam; and receiving the PUSCH portion of the random access message via the wide beam; transmitting a random access response message, wherein the random access response message indicates a narrow beam from among the plurality of narrow beams in accordance with receiving the plurality of repetitions of the PRACH portion of the random access message; and communicating via the narrow beam in accordance with transmitting the random access response message.

Aspect 16: The method of aspect 15, further comprising: transmitting one or more SSBs, wherein the wide beam is associated with a SSB of the one or more SSBs.

Aspect 17: The method of aspect 16, wherein receiving the plurality of repetitions of the PRACH portion of the random access message comprises: receiving each repetition of the plurality of repetitions of the PRACH portion of the random access message in accordance with a transmission power, wherein the transmission power is in accordance with transmitting the SSB.

Aspect 18: The method of any of aspects 16 through 17, wherein receiving the plurality of repetitions of the PRACH portion of the random access message is in accordance with a RSRP associated with the SSB being greater than or equal to a first threshold, being less than a second threshold, or both.

Aspect 19: The method of any of aspects 16 through 18, further comprising: receiving a second plurality of repetitions of the PRACH portion of the random access message via the wide beam in accordance with a RSRP associated with the SSB failing to satisfy a first threshold.

Aspect 20: The method of any of aspects 15 through 19, wherein communicating via the narrow beam comprises: receiving, via the narrow beam, a feedback message indicating successful reception of the random access response message.

Aspect 21: The method of any of aspects 15 through 20, further comprising: identifying, for an earliest detected repetition of the PRACH portion of the random access message from among the plurality of repetitions of the PRACH portion of the random access message, a radio network temporary identifier that is associated with a RO corresponding to the earliest detected repetition; and transmitting a control message that schedules the random access response message, wherein the control message is associated with the radio network temporary identifier in accordance with the radio network temporary identifier being associated with the RO corresponding to the earliest detected repetition.

Aspect 22: The method of any of aspects 15 through 21, wherein receiving the plurality of repetitions of the PRACH portion of the random access message comprises: receiving each of the plurality of repetitions of the PRACH portion of the random access message using a common preamble.

Aspect 23: The method of any of aspects 15 through 22, wherein communicating via the narrow beam comprises: receiving a second random access message via the narrow beam, the second random access message comprising a PUSCH message.

Aspect 24: The method of any of aspects 15 through 23, further comprising: receiving, prior to transmitting the random access response message, at least one additional random access message in accordance with a reception or decoding failure for a prior random access response message, wherein receiving each additional random access message comprises: receiving a plurality of repetitions of a PRACH portion of the additional random access message via the plurality of narrow beams associated with the wide beam; and receiving a PUSCH portion of the additional random access message via the wide beam.

Aspect 25: The method of aspect 24, wherein receiving the at least one additional random access message comprises: receiving one or more additional random access messages until a threshold quantity of random access messages is satisfied.

Aspect 26: The method of any of aspects 15 through 25, further comprising: transmitting system information indicating a beam sweep configuration, wherein transmitting the plurality of repetitions of the PRACH portion of the random access response message is in accordance with the beam sweep configuration.

Aspect 27: The method of aspect 26, wherein the beam sweep configuration indicates a quantity of repetitions of the PRACH portion of the random access message, a threshold quantity of random access message retransmissions, a fallback random access message transmission configuration, or any combination thereof.

Aspect 28: The method of any of aspects 15 through 27, wherein the beam sweep configuration indicates a plurality of sets of ROs, wherein receiving the plurality of repetitions of the PRACH portion of the random access message is via a set of ROs from among the plurality of sets of ROs, and wherein the beam sweep configuration indicates a plurality of POs, wherein each PO is associated with a respective set of ROs among the plurality of sets of ROs, and wherein receiving the PUSCH portion of the random access message is via a PO associated with the set of ROs.

Aspect 29: A UE for wireless communications, comprising one or more memories storing processor-executable code, and one or more processors coupled with the one or more memories and individually or collectively operable to execute the code to cause the UE to perform a method of any of aspects 1 through 14.

Aspect 30: A UE for wireless communications, comprising at least one means for performing a method of any of aspects 1 through 14.

Aspect 31: A non-transitory computer-readable medium storing code for wireless communications, the code comprising instructions executable by one or more processors to perform a method of any of aspects 1 through 14.

Aspect 32: A network entity for wireless communications, comprising one or more memories storing processor-executable code, and one or more processors coupled with the one or more memories and individually or collectively operable to execute the code to cause the network entity to perform a method of any of aspects 15 through 28.

Aspect 33: A network entity for wireless communications, comprising at least one means for performing a method of any of aspects 15 through 28.

Aspect 34: A non-transitory computer-readable medium storing code for wireless communications, the code comprising instructions executable by one or more processors to perform a method of any of aspects 15 through 28.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Also, as used herein, the phrase “a set” shall be construed as including the possibility of a set with one member. That is, the phrase “a set” shall be construed in the same manner as “one or more.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
transmit a random access message that comprises a physical random access channel portion and a physical uplink shared channel portion, wherein, to transmit the random access message, the one or more processors are individually or collectively operable to execute the code to cause the UE to:
transmit a plurality of repetitions of the physical random access channel portion of the random access message via a plurality of narrow beams associated with a wide beam; and
transmit the physical uplink shared channel portion of the random access message via the wide beam;
receive a random access response message, wherein the random access response message indicates a narrow beam from among the plurality of narrow beams in accordance with transmitting the plurality of repetitions of the physical random access channel portion of the random access message; and
communicate via the narrow beam in accordance with receiving the random access response message.

2. The UE of claim 1, wherein the one or more processors are individually or collectively further operable to execute the code to cause the UE to:
receive one or more synchronization signal blocks, wherein the wide beam is associated with a synchronization signal block of the one or more synchronization signal blocks.

3. The UE of claim 2, wherein, to transmit the plurality of repetitions of the physical random access channel portion of the random access message, the one or more processors are individually or collectively operable to execute the code to cause the UE to:
transmit each repetition of the plurality of repetitions of the physical random access channel portion of the random access message in accordance with a transmission power, wherein the transmission power is in accordance with a measured path loss associated with the synchronization signal block.

4. The UE of claim 2, wherein the one or more processors are individually or collectively operable to execute the code to cause the UE to transmit the plurality of repetitions of the physical random access channel portion of the random access message in accordance with a reference signal received power associated with the synchronization signal block being greater than or equal to a first threshold, being less than a second threshold, or both.

5. The UE of claim 2, wherein the one or more processors are individually or collectively further operable to execute the code to cause the UE to:
transmit a second plurality of repetitions of the physical random access channel portion of the random access message via the wide beam in accordance with a reference signal received power associated with the synchronization signal block failing to satisfy a first threshold.

6. The UE of claim 1, wherein, to communicate via the narrow beam, the one or more processors are individually or collectively operable to execute the code to cause the UE to:
transmit, via the narrow beam, a feedback message indicating successful reception of the random access response message.

7. The UE of claim 1, wherein, to transmit the plurality of repetitions of the physical random access channel portion of the random access message, the one or more processors are individually or collectively operable to execute the code to cause the UE to:
transmit each of the plurality of repetitions of the physical random access channel portion of the random access message using a common preamble.

8. The UE of claim 1, wherein, to communicate via the narrow beam, the one or more processors are individually or collectively operable to execute the code to cause the UE to:
transmit a second random access message via the narrow beam, the second random access message comprising a physical uplink shared channel message.

9. The UE of claim 1, wherein the one or more processors are individually or collectively further operable to execute the code to cause the UE to:
transmit, prior to receiving the random access response message, at least one additional random access message in accordance with a failure to receive or decode a prior random access response message, wherein, to transmit each additional random access message, the one or more processors are individually or collectively operable to execute the code to cause the UE to:
transmit a plurality of repetitions of a physical random access channel portion of the additional random access message via the plurality of narrow beams associated with the wide beam; and
transmit a physical uplink shared channel portion of the additional random access message via the wide beam.

10. The UE of claim 9, wherein, to transmit the at least one additional random access message, the one or more processors are individually or collectively operable to execute the code to cause the UE to:
transmit one or more additional random access messages until a threshold quantity of random access messages is satisfied.

11. The UE of claim 1, wherein the one or more processors are individually or collectively further operable to execute the code to cause the UE to:
receive system information indicating a beam sweep configuration, wherein transmitting the plurality of repetitions of the physical random access channel portion of the random access response message is in accordance with the beam sweep configuration.

12. The UE of claim 11, wherein the beam sweep configuration indicates a quantity of repetitions of the physical random access channel portion of the random access message, a threshold quantity of random access message retransmissions, a fallback random access message transmission configuration, or any combination thereof.

13. The UE of claim 11, wherein:
the beam sweep configuration indicates a plurality of sets of random access channel occasions, wherein the one or more processors are individually or collectively operable to execute the code to cause the UE to transmit the plurality of repetitions of the physical random access channel portion of the random access message via a set of random access channel occasions from among the plurality of sets of random access channel occasions, and
the beam sweep configuration indicates a plurality of physical uplink shared channel occasions, wherein each physical uplink shared channel occasion is associated with a respective set of random access channel occasions among the plurality of sets of random access channel occasions, and wherein the one or more processors are individually or collectively operable to execute the code to cause the UE to transmit the physical uplink shared channel portion of the random access message via a physical uplink shared channel occasion associated with the set of random access channel occasions.

14. The UE of claim 13, wherein the one or more processors are individually or collectively further operable to execute the code to cause the UE to:
select, by the UE, the set of random access channel occasions from among the plurality of sets of random access channel occasions.

15. A network entity, comprising:
one or more memories storing processor-executable code; and
one or more processors coupled with the one or more memories and individually or collectively operable to execute the code to cause the network entity to:
receive a random access message that comprises a physical random access channel portion and a physical uplink shared channel portion, wherein, to receive the random access message, the one or more processors are individually or collectively operable to execute the code to cause the network entity to:
receive a plurality of repetitions of the physical random access channel portion of the random access message via a plurality of narrow beams associated with a wide beam; and
receive the physical uplink shared channel portion of the random access message via the wide beam;
transmit a random access response message, wherein the random access response message indicates a narrow beam from among the plurality of narrow beams in accordance with receiving the plurality of repetitions of the physical random access channel portion of the random access message; and
communicate via the narrow beam in accordance with transmitting the random access response message.

16. The network entity of claim 15, wherein the one or more processors are individually or collectively further operable to execute the code to cause the network entity to:
transmit one or more synchronization signal blocks, wherein the wide beam is associated with a synchronization signal block of the one or more synchronization signal blocks.

17. The network entity of claim 15, wherein, to communicate via the narrow beam, the one or more processors are individually or collectively operable to execute the code to cause the network entity to:
receive, via the narrow beam, a feedback message indicating successful reception of the random access response message.

18. The network entity of claim 15, wherein the one or more processors are individually or collectively further operable to execute the code to cause the network entity to:
identify, for an earliest detected repetition of the physical random access channel portion of the random access message from among the plurality of repetitions of the physical random access channel portion of the random access message, a radio network temporary identifier that is associated with a random access channel occasion corresponding to the earliest detected repetition; and
transmit a control message that schedules the random access response message, wherein the control message is associated with the radio network temporary identifier in accordance with the radio network temporary identifier being associated with the random access channel occasion corresponding to the earliest detected repetition.

19. The network entity of claim 15, wherein the one or more processors are individually or collectively further operable to execute the code to cause the network entity to:
transmit system information indicating a beam sweep configuration, wherein transmitting the plurality of repetitions of the physical random access channel portion of the random access response message is in accordance with the beam sweep configuration.

20. A method for wireless communications at a user equipment (UE), comprising:
transmitting a random access message that comprises a physical random access channel portion and a physical uplink shared channel portion, wherein transmitting the random access message comprises:
transmitting a plurality of repetitions of the physical random access channel portion of the random access message via a plurality of narrow beams associated with a wide beam; and
transmitting the physical uplink shared channel portion of the random access message via the wide beam;
receiving a random access response message, wherein the random access response message indicates a narrow beam from among the plurality of narrow beams in accordance with transmitting the plurality of repetitions of the physical random access channel portion of the random access message; and
communicating via the narrow beam in accordance with receiving the random access response message.
